(19) United States
(12) Patent Application Publication
(10) Pub. No.: US 2025/0008483 A1
(43) Pub. Date: Jan. 2, 2025

(54) MANAGING PAGING FOR MULTICAST AND/OR BROADCAST SERVICES (MBS) SERVICES

(71) Applicant: GOOGLE LLC, Mountain View, CA (US)

(72) Inventors: Chih-Hsiang Wu, Taoyuan City (TW); Jing-Rong Hsieh, Taipei City (TW)

(21) Appl. No.: 18/701,172

(22) PCT Filed: Oct. 18, 2022
(86) PCT No.: PCT/US22/46933

§ 371 Date: Apr. 12, 2024

Related U.S. Application Data
(60) Provisional application No. 63/270,006, filed on Oct. 20, 2021.

(51) Int. Cl. H04W 68/00; H04W 76/27; H04W 76/40

(52) U.S. Cl. CPC H04W 68/005; H04W 76/27; H04W 76/40

(57) ABSTRACT

Managing paging for Multicast and/or Broadcast Services (MBSs) of interested UEs that do not have an active radio connection with the RAN can include providing, in MBS service paging instructions, indications of respective radio capabilities of interested UEs in conjunction with the identifications of the interested UEs, e.g., so that DUs can have necessary UE radio capability information in-line with the paging instructions. Another technique can include a base station providing an indication of UE radio capability information of interested UEs to another base station. Still another technique includes storing, at a DU or at a CU, an indication of UE radio capabilities and/or a default or predetermined set of UE radio capabilities for use in paging interested UEs.

### FIELD OF THE DISCLOSURE

This disclosure relates to wireless communications and, more particularly, to managing paging for multicast and/or broadcast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures.

In some scenarios, a UE can operate in a state in which a radio resource control connection with the RAN is not active (e.g., RRC_IDLE or RRC_INACTIVE state) and subsequently transition to the connected state. Generally speaking, in the inactive state, the radio connection between the UE and the radio access network (RAN) is suspended. Later, when the UE is triggered to send data (e.g., outgoing phone call, browser launch) or receives a paging message from the base station, the UE can then transition to the connected state. To carry out the transition, the UE can request that the base station establish a radio connection (e.g., by sending an RRC Setup Request message to the base station) or resume the suspended radio connection (e.g., by sending an RRC Resume Request message to the base station), so that the base station can configure the UE to operate in the connected state.

In some cases, the UE in the RRC_IDLE or RRC_INACTIVE state has only one or some, relatively small packets to transmit or the base station has only one or some, relatively small packets to transmit to the UE operating in the RRC_IDLE or RRC_INACTIVE state. In these cases, the UE in the RRC_IDLE or RRC_INACTIVE state can perform an early data communication without transitioning to the RRC_CONNECTED state, e.g., by using techniques as specified in section 7.3a-7.3d in 3GPP specification 36.300 v16.4.0.

Recently, 3GPP has discussed providing multicast paging for Multicast and/or Broadcast Services (MBS), that is, by transmitting a multicast paging message or instruction which indicates that UEs that have previously indicated an interest in a particular MBS service and that are not operating in an active state are to be paged for the MBS service. For example, a Core Network (CN) can receive MBS data that is to be transmitted to multiple interested UEs, and based on the received MBS data, the CN can transmit, to a Central Unit (CU) of a distributed base station (BS), a multicast paging message which identifies the set of UEs interested in the MBS service. The CU can transmit one or more corresponding multicast paging messages to Distributed Units (DUs) of the distributed base station, where each CU-to-DU multicast paging message indicates one or more interested UEs associated with the recipient DU.

However, multicast paging for MBS presents several challenges. For example, a DU does not store or otherwise have any information of the radio capabilities of associated UEs for preparing and transmitting the paging messages. Similarly, in some situations, such as when an interested UE is in the RRC_IDLE state, neither the CU nor the DU stores or otherwise has any information of the radio capabilities of UEs which are interested in the MBS service. Such situations can result in extra messaging upstream (e.g., towards the CN) for the DU to obtain needed radio configuration capabilities as well as delays in establishing an MBS session via which interested UEs can receive content data of the MBS service.

### SUMMARY

Nodes of a radio access network (RAN) can use one or more of the techniques described in this document to manage paging for Multicast and/or Broadcast Services (MBS) of interested UEs that do not have an active radio connection with the RAN. The techniques can be utilized in-line with receiving an MBS paging instruction (e.g., without needing to query upstream components or nodes of the RAN and wireless communication system) and without delaying the establishment of MBS sessions and MBS content data delivery to the interested UEs. An example technique includes providing, in MBS service paging instructions, indications of respective radio capabilities of interested UEs in conjunction with the identifications of the interested UEs so that DUs can have necessary UE radio capability information in-line with the paging instructions. Such UE capability information can be provided by any upstream component or node of the wireless communication system (e.g., CN, CU, etc.) to a corresponding downstream component or node (e.g., integrated BS or CU, DU, etc.). Another example technique includes storing, at the DUs, indications of respective radio capability information of one or more interested UEs. Still another example technique allows base stations to provide indications of radio capability information of interested UEs to other base stations, e.g., when an interested UE moves into the coverage area of the other base stations. Further, and advantageously, the techniques for managing paging for MBS services described in this document are compatible with known techniques for managing paging for unicast services.

An example embodiment of these techniques is a method, in a Core Network (CN) of a wireless communication system, for managing paging of multiple User Equipments (UEs) interested in a Multicast-Broadcast Services (MBS) service when respective radio connections between the multiple UEs and respective base stations of the wireless communication system are not active, e.g., the respective radio connections are idle or inactive. The method includes generating, by processing hardware of the CN, a set of paging instructions to page the multiple UEs interested in the MBS service, where the set of paging instructions includes an indication of a respective set of radio capabilities of each UE of the multiple UEs; and transmitting, by the processing hardware, the set of paging instructions to one or more base stations of the wireless communication system thereby causing the each UE to be paged in accordance with its respective set of radio capabilities for activating data reception of the MBS service.

Another example embodiment of these techniques is a method in a Distributed Unit (DU) of a distributed base station of a Radio Access Network (RAN), the distributed base station including the DU and a central unit (CU), for managing paging of multiple User Equipments (UEs) interested in a Multicast and Broadcast Services (MBS) service when respective radio connections between the multiple UEs and respective base stations of the wireless communication system are not active, e.g., the respective radio connections are idle or inactive. The method includes receiving, by processing hardware of the DU from the CU, a single multicast paging message including a session identifier of an MBS session of the MBS service and a respective identification of each UE included in the multiple UEs; and paging, by the processing hardware, each UE of the multiple UEs for the MBS service, where the paging is in accordance with a respective set of radio capabilities of each identified UE and the paging indicates the MBS session identifier.

Yet another example embodiment of these techniques is a method in a Central Unit (CU) of a distributed base station of a Radio Access Network (RAN), the distributed base station including the CU and a distributed unit (DU), for managing paging of one or more User Equipments (UEs) interested in a Multicast and/or Broadcast Services (MBS) service when respective radio connections between the one or more UEs and respective base stations of the wireless communication system are not active, e.g., the respective radio connection are idle or inactive. The method includes receiving, by processing hardware of the CU from a Core Network (CN) or another base station, a transmission corresponding to the one or more UEs interested in the MBS service; and transmitting, by the processing hardware to the DU, a set of paging instructions to the DU thereby causing the DU to page each UE of the one or more UEs in accordance with a respective set of radio capabilities for activating data reception of the MBS service at each of the paged UEs.

Another example embodiment of these techniques is a method, in a base station (BS) of a wireless communication system, for paging multiple User Equipments (UEs) interested in a Multicast Services and/or Broadcast Services (MBS) service when respective radio connections between the multiple UEs and respective base stations of the wireless communication system are not active, e.g., the respective radio connections are idle or inactive. The method includes receiving, by processing hardware of the BS, a single multicast paging message including a session identifier of an MBS session of the MBS service, respective identifications of the multiple UEs, and an indication of respective set of radio capabilities of the multiple UEs. The method further includes, responsive to receiving the single multicast paging message: generating, by the processing hardware, a respective paging message corresponding to each UE of the multiple UEs, the respective paging message including the MBS session identifier; generating, by the processing hardware for the each UE, an indication of a respective time domain resource allocation, a respective frequency domain resource allocation, and a respective modulation scheme that are in accordance with the respective set of radio capabilities of the each UE; transmitting, by the processing hardware in in accordance with the respective set of radio capabilities of the each UE, the indication of the respective time domain resource allocation, the respective frequency domain resource allocation, and the respective modulation scheme corresponding to the each UE via one or more shared downlink control channels; and transmitting, by the processing hardware in accordance with the respective set of radio capabilities of the each UE, the respective paging message corresponding to the each UE via one or more shared downlink data channels.

Still another example embodiment of these techniques is a method, in a Radio Access Network (RAN) node of a wireless communication system, for paging a User Equipment interested in a Multicast and/or Broadcast Services (MBS) service when a radio connection between the UE and the RAN node is not active, e.g., the radio connection is idle or inactive. The method includes determining, by processing hardware of the RAN node, whether an indication of a set of radio capabilities of the UE is stored at the RAN node. When the indication of the set of radio capabilities of the UE is stored at the RAN node, the method includes paging, by the processing hardware, the UE in accordance with the stored indication. When the indication of the set of radio capabilities of the UE is not stored at the RAN node, the method includes: (i) one of: obtaining, by the processing hardware, an indication of a default set of radio capabilities, the indication of the default set of radio capabilities stored at the RAN node; or obtaining, by the processing hardware, the indication of the set of radio capabilities of the UE from another node of the wireless communication system, the another node being a Core Network (CN) or another RAN node; and (ii) paging, by the processing hardware, the UE in accordance with the obtained indication.

Still, another example embodiment of these techniques is a method, in a base station (BS) of a wireless communication system for paging multiple User Equipments (UEs) interested in a Multicast-Broadcast Services (MBS) service when respective radio connections between the multiple UEs and respective base stations of the wireless communication system are not active, e.g., the respective radio connections are idle or inactive. The method includes determining, by processing hardware of the BS, to page the multiple UEs via another BS; generating, by the processing hardware, a single multicast paging message including a session identifier of an MBS session of the MBS service, respective identifications of the multiple UEs, and one or more indications of respective set(s) of radio capabilities of the multiple UEs; and transmitting, by the processing hardware, the single multicast paging message to the another BS.

Yet another example embodiment of these techniques is a wireless communication system for managing the paging of one or more user equipments (UEs) interested in a Multicast and Broadcast Services (MBS) service when respective radio connections between the one or more UEs and respective base stations of the wireless communication system are not active, e.g., the respective radio connections are idle or inactive. The system includes a first component, which can be a core network (CN), a base station (BS), or a Central Unit (CU) of the BS. The first component is configured to: generate a set of paging instructions to page the one or more UEs interested in the MBS service, where the set of paging instructions includes an indication of a respective set of radio capabilities of each UE of the one or more UEs; and transmit the set of paging instructions to one or more receiving components of the wireless communication system thereby causing each UE to be paged in accordance with its respective set of radio capabilities for activating data reception of the MBS service via a shared session of the MBS service.

### BRIEF DESCRIPTION OF THE DRAWINGS

FIG. 1A is a block diagram of an example wireless communication system in which a Core Network (CN), a base station (BS), and a User Equipment (UE) can implement the techniques of this disclosure for managing multicast paging for Multicast and/or Broadcast Services (MBS);

FIG. 1B is a block diagram of an example base station (BS) including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions;

FIG. 4 is a block diagram illustrating example MRBs and DRBs which a distributed base station can configure for communicating multicast, broadcast, and/or unicast traffic with UEs;

FIG. 5A is a messaging diagram of an example scenario in which a CN and a distributed base station configure resources for transmitting MBS data of an MBS session to multiple UEs;

FIG. 5B is a messaging diagram of an example scenario in which a CN and a distributed base station configure resources for transmitting MBS data of an MBS session to multiple UEs;

FIG. 6A is an example message sequence in which a CN transmits a single multicast paging message for an MBS service to a CU of a BS, the CU transmits a corresponding single multicast paging message to a DU, and the DU pages one or more UEs that are interested in the MBS service while the UEs are operating in an idle state or an inactive state to thereby activate data reception for the MBS service at the UEs without changing state;

FIG. 6B is an example message sequence in which a CN transmits content data of an MBS service to a CU of a BS, the CU transmits the MBS content data to a DU, which triggers the DU to page one or more UEs that are interested in the MBS service while the UEs are operating in an inactive state to thereby activate data reception for the MBS service at the UEs without changing state;

FIG. 6C is an example message sequence in which a CN transmits content data of an MBS service to a CU of a BS, which triggers the CU to transmit a corresponding single multicast paging message for the MBS service to a DU, and the DU pages one or more UEs that are interested in the MBS service when the UEs are operating in an inactive state to thereby activate data reception for the MBS service at the UEs without changing state;

FIG. 6D is an example message sequence in which a CN and a BS activate data reception for an MBS service at an interested UE that is operating in the idle state, the UE connects to the BS and begins operating in the connected state, and the CN delivers MBS content data to the UE operating in the connected state.

FIG. 6E is an example message sequence in which a CN and a BS activate data reception for an MBS service at an interested UE operating in the inactive state, the UE resumes a connection to the BS and begins operating in the connected state, and the CN delivers MBS content data to the UE operating in the connected state;

FIG. 6F is an example message sequence in which multiple UEs operating in the inactive state and disposed in a first location associated with a first BS are interested in an MBS service, a first UE remains at the first location and a second UE moves to a second location associated with a second BS, the first BS transmits a single multicast paging message for the MBS service to the second BS, and the second BS pages the second UE to activate data reception for the MBS service at the UE so the second UE receives content data of the MBS service from the CN via the second BS while in the connected state and the first UE receives the MBS content data via the first BS while in the inactive state;

FIG. 7A is an example message sequence in which a CN transmits a single multicast paging message for an MBS service to a CU of a BS, the CU transmits, to a DU, a respective unicast paging message to each UE indicated in the single multicast paging message, and the DU individually pages each of the UEs while the UEs are operating in an idle state or an inactive state to thereby activate data reception for the MBS service at the UEs;

FIG. 7B is an example message sequence in which a CN transmits a single multicast paging message for an MBS service to a CU of a BS, the CU transmits a corresponding single multicast paging message to the DU, the DU individually pages each of the UEs while the UEs are operating in an idle state or an inactive state to thereby activate data reception for the MBS service at the UEs;

FIG. 7C is an example message sequence in which multiple UEs operating in an idle state or in an inactive state move from a first location associated with a first base station to a second location associated with a second base station, the CN transmits a single multicast paging message for the MBS service to the first base station, the first base station transmits a respective unicast message for each UE indicated in the single multicast paging message to the second base station, and the second base station individually pages each of the UEs to thereby activate data reception for the MBS service at the UEs;

FIG. 7D is an example message sequence in which multiple UEs operating in an inactive state move from a first location associated with a first base station to a second location associated with a second base station, the CN transmits a single multicast paging message indicating multiple UEs interested in the MBS service to the first base station, the first base station transmits a corresponding single multicast paging message to the second base station, and the second base station individually pages each of the indicated UEs to thereby activate data reception for the MBS service at the UEs;

FIG. 8A is a flow diagram of an example method for generating a single multicast paging message indicating multiple UEs interested in an MBS service and transmitting the multicast paging message to one or more DUs, where the example method can be implemented by a CU;

FIG. 8B is a flow diagram of an example method for generating a respective unicast paging message for each UE included in a set of multiple UEs interested in an MBS service and transmitting the unicast paging messages to one or more DUs, where the example method can be implemented by a CU;

FIG. 9 is a flow diagram of an example method for determining if paging of UEs is for an MBS service or for a unicast service, generating and transmitting a single multicast paging message to a first at least one DU when the service is an MBS service, and generating and transmitting a unicast paging message to a second at least one DU when the service is a unicast service, where the example method can be implemented by a CU;

FIG. 10A is a flow diagram of an example method for receiving, from a CU, a single multicast paging message for an MBS service, and generating and transmitting a corresponding paging message for each UE indicated in the received multicast paging message, where the example method can be implemented by a DU;

FIG. 10B is a flow diagram of an example method for receiving, from a CN, a single multicast paging message for an MBS service, and generating and transmitting a corresponding unicast paging message for each UE indicated in the received multicast paging message, where the example method can be implemented by a BS;

FIG. 10C is a flow diagram of an example method for receiving, from a first Radio Access Network (RAN) node, a single multicast paging message for an MBS service, and generating and transmitting a corresponding unicast paging message for each UE indicated in the received multicast paging message, where the example method can be implemented by a second RAN node;

FIG. 11 is a flow diagram for an example method, which can be implemented by a RAN node, for paging a UE in accordance with a stored radio capability corresponding to the UE or paging the UE in accordance with a predetermined or default radio capability when the RAN node does not store a radio capability corresponding to the UE;

FIG. 12A is a flow diagram for an example method for generating a single multicast paging message indicating multiple UEs interested in an MBS service and transmitting the single multicast paging message to one or more RAN nodes or base stations, where the example method can be implemented by a CN;

FIG. 12B is a flow diagram for an example method for generating a respective unicast paging message for each UE included in a set of UEs interested in an MBS service and transmitting the unicast paging messages to one or more RAN nodes or base stations, where the example method can be implemented by a CN;

FIG. 13A is a flow diagram for an example method for generating a single multicast paging message indicating multiple UEs interested in an MBS service and transmitting the single multicast paging message to one or more RAN nodes, where the example method can be implemented by another RAN node;

FIG. 13B is a flow diagram for an example method for generating a respective unicast paging message for each UE included in a set of UEs interested in an MBS service and transmitting the unicast paging messages to one or more RAN nodes, where the example method can be implemented by another RAN node;

FIG. 14 is a flow diagram of an example method for determining if paging of UEs is for an MBS service or for a unicast service, generating and transmitting a single multicast paging message to a first at least one RAN node when the service is an MBS service, and generating and transmitting a unicast paging message to a second at least one RAN node when the service is a unicast service, where the example method can be implemented by a CN; and

FIG. 15 is a flow diagram of an example method for determining if paging of UEs is for an MBS service or for a unicast service, generating and transmitting a single multicast paging message to a first at least one RAN node when the service is an MBS service, and generating and transmitting a unicast paging message to a second at least one RAN node when the service is a unicast service, where the example method can be implemented by another RAN node.

### DETAILED DESCRIPTION OF THE DRAWINGS

Generally speaking, one or more nodes of a wireless communication system (e.g., a CN, base station, RAN node, CU, and/or DU) implement the techniques of this disclosure to manage paging of UEs for multicast and/or broadcast services (MBS) and, in some scenarios, in concert with managing paging of UEs for unicast services. This document interchangeably utilizes the terms “Multicast-Broadcast Services,” “Multicast and Broadcast Services,” “Multicast Services and/or Broadcast Services,” and “Multicast and/or Broadcast Services” to generally refer to a point-to-multipoint communication and/or data service or scheme, where the acronym “MBS” refers to any or all of these terms, individually and/or collectively. Additionally, this document utilizes the term “unicast service” to generally refer to a point-to-point communication and/or data service or scheme.

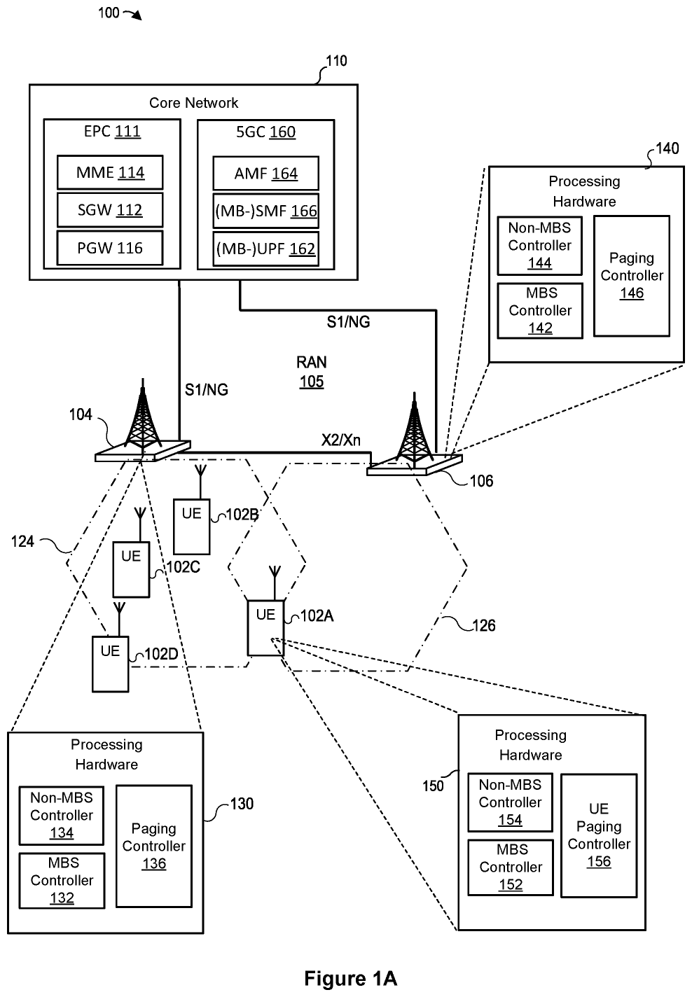

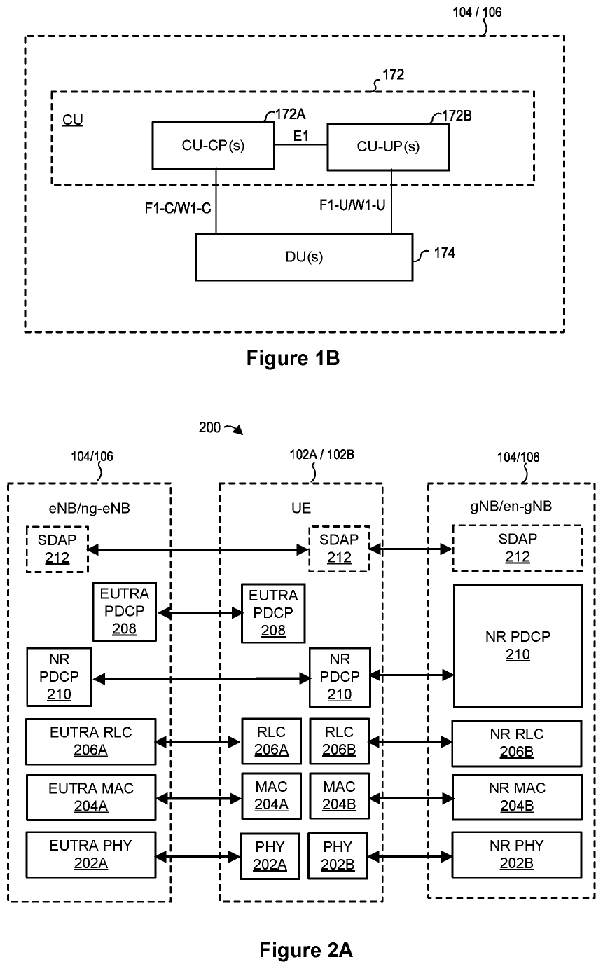

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation. Further, the processing hardware 130 in an example implementation includes one or more paging controllers 136 configured to manage MBS and non-MBS (e.g., unicast services) paging operations with one or more UEs operating in the RRC_INACTIVE or RRC_IDLE state.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142, a non-MBS controller 144, and one or more paging controllers 146, which may be similar to the controllers 132, 134, 136, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Further, the processing hardware 150 in an example implementation includes one or more paging controllers 156 configured to manage MBS and non-MBS (e.g., unicast services) paging operations with one or more base stations (e.g., BS 104, 106) when the UE 102A is operating in the RRC_INACTIVE or RRC_IDLE state. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 can include a user plane function (UPF) 162 and an access and mobility management function (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast services and MBS services, or for MBS services only, as denoted by the prefix “(MB-)” shown in FIG. 1A.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

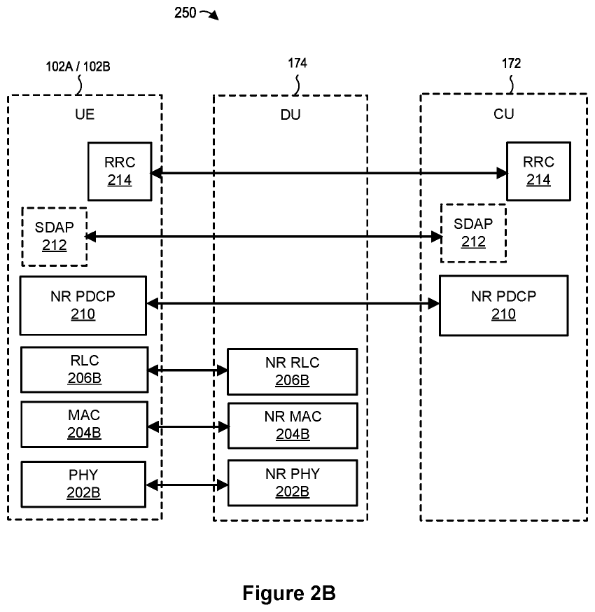

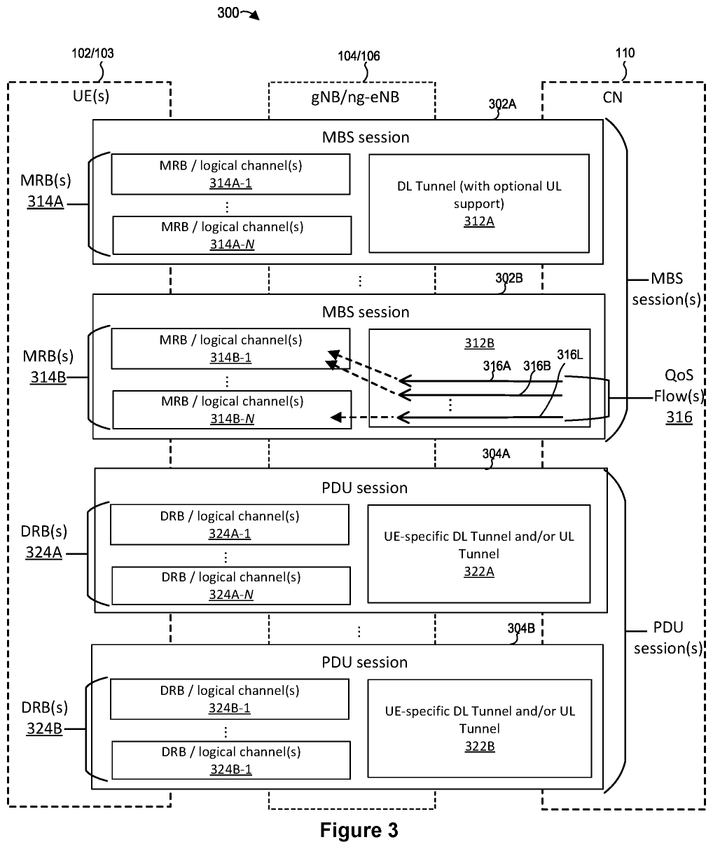

FIG. 2A illustrates, in a simplified manner, an example protocol stack 200 according to which a UE (e.g., UE 102A or 102B) can communicate with an eNB/ng-eNB or a gNB (e.g., one or more of the base stations 104, 106). In the example protocol stack 200, a PHY sublayer 202A of EUTRA provides transport channels to a EUTRA MAC sublayer 204A, which in turn provides logical channels to a EUTRA RLC sublayer 206A. The EUTRA RLC sublayer 206A in turn provides RLC channels to a EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A or 102B, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A or 102B can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A or 102B operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE 102A or 102B with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A or 102B receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A or 102B uses PHY sublayer 202, MAC sublayer 204, and RLC sublayer 206 to receive the MBS data packets. In such implementations, the base station and the UE 102A or 102B may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A of 102B uses PHY sublayer 202, MAC sublayer 204, RLC sublayer 206 and PDCP sublayer 208 to receive the MBS data packets. In such implementations, the base station and the UE 102A or 102B may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A or 102B uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE 102A or 102B can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QoS) flows, for each of the tunnels 312A, 312B, etc. For example, the MBS traffic on the tunnel 312B can include a set of flows 316 including QoS flows 316A, 316B, . . . , 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . , 324A-N. Each of the DRBs 324A can correspond to a respective logical channel, such as a Dedicated Traffic Channel (DTCH). The base station 104/106 and the CN 110 can also maintain one or more other PDU sessions to support unicast traffic between the CN 110 and particular UEs. For example, PDU session 304B can include a UE-specific DL tunnel and/or UE-specific UL tunnel 322B corresponding to one or more DRBs 324B, such as a DRB 324B-1, 324B-2, . . . , 324B-N. Each of the DRBs 324B can correspond to a respective logical channel, such as a DTCH.

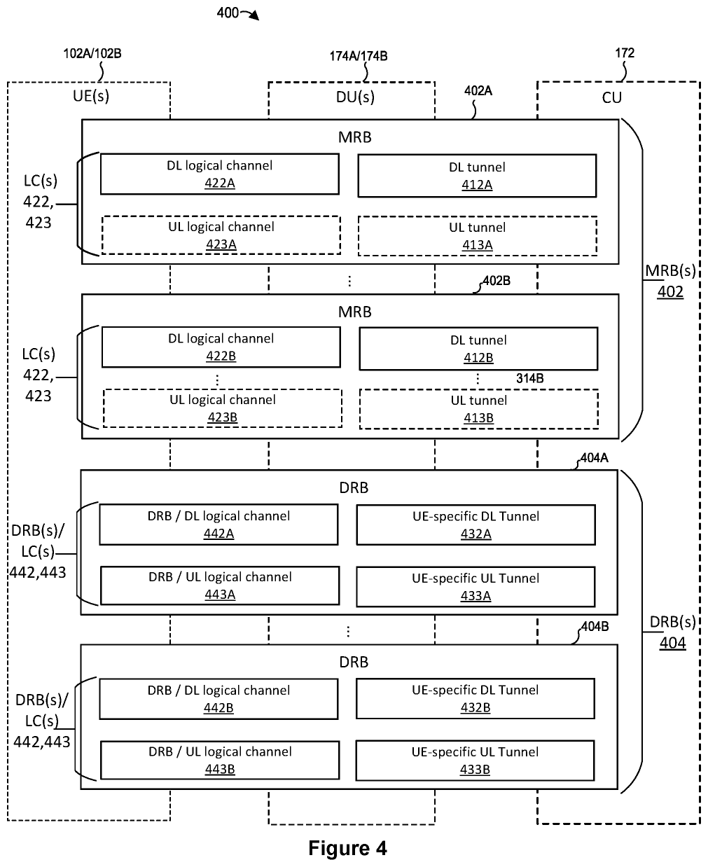

Now referring to FIG. 4, when the base station 104/106 is implemented in a distributed manner, one or more DUs 174A/174B can be associated with the CU 172. The CU 172 and the DU(s) 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU(s) 174A/174B, and a DL logical channel 422A corresponding to the DL tunnel 412A. In particular, the DU(s) 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU(s) 174A/174B, and a UL logical channel 423A corresponding to the UL tunnel 413A. The UL logical channel 423A can be a DTCH, for example. The DU(s) 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU(s) 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU(s) 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU(s) 174A/174B, and a DL logical channel 442A corresponding to the DL tunnel 432A. In particular, the DU(s) 174A/174B can map downlink traffic received via the DL tunnel 432A to the DL logical channel 442A, which can be a DTCH, for example. The DRB 404A further includes a UE-specific UL tunnel 433A connecting the CU 172 and the DU(s) 174A/174B, and a UL logical channel 443A corresponding to the UL tunnel 433A. The UL logical channel 443A can be a PUSCH, for example. The DU(s) 174A/174B can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

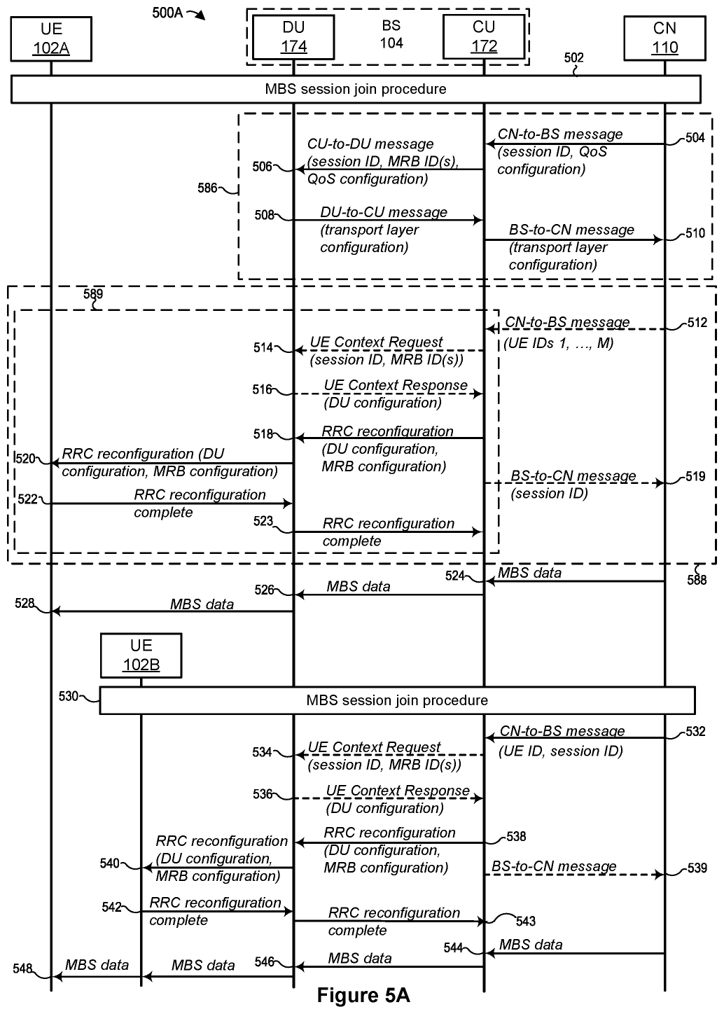

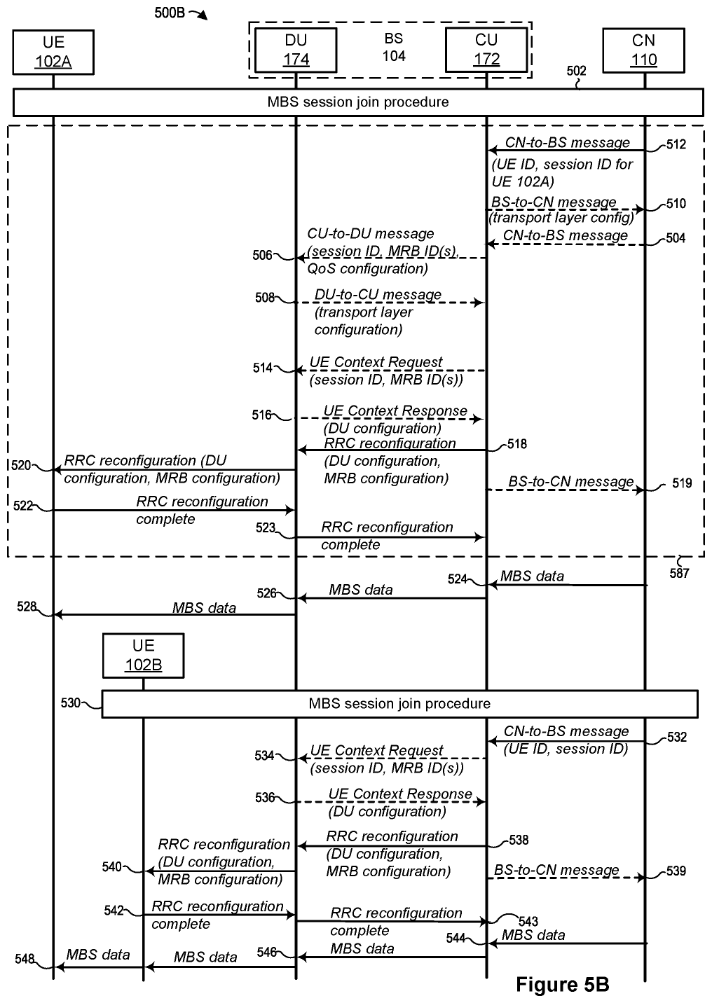

Referring to FIG. 5A, the UE 102A in a scenario 500A initially performs 502 an MBS session join procedure with the CN 110 via the base station 104 to join a certain MBS session. In some scenarios, the UE 102A subsequently performs additional one or more MBS join procedures, and event 502 accordingly is a first one of multiple MBS join procedures. When the base station 104 configures a common DL tunnel for MBS traffic rather than a UE-specific tunnel, the procedures 502 and 586 can occur in either order. In other words, the base station 104 can configure a common DL tunnel before even a single UE joins the MBS session.

To perform the MBS session join procedure (event 502), the UE 102A in some implementations sends an MBS session join request message to the CN 110 via the base station 104. In response, the CN 110 can send an MBS session join response message to the UE 102A via the base station 104 to grant the UE 102A access to the first MBS session. In some implementations, the UE 102A can include an MBS session ID of the MBS session in the MBS session join request message. The CN 110 in some cases includes the MBS session ID in the MBS session join response message. In some implementations, the UE 102A can send an MBS session join complete message to the CN 110 via the base station 104 in response to the MBS session join response message.

The UE 102A in some cases performs additional MBS session join procedure(s) with the CN 110 via the RAN 105 (e.g., the base station 104 or base station 106) to join additional MBS session(s). For example, the UE 102A can perform a second MBS session join procedure with the CN 110 via the RAN 105 to join a second MBS session. Similar to event 502, the UE 102A in some implementations can send a second MBS session join request message to the CN 110 via the base station 104, and the CN 110 can respond with a second MBS session join response message to grant the UE 102A access to the second MBS session. In some implementations, the UE 102A can send a second MBS session join complete message to the CN 110 via the base station 104 in response to the second MBS session join response message. In some implementations, the UE 102A can include a second MBS session ID of the second MBS session in the second MBS session join request message. The CN 110 optionally includes the second MBS session ID in the second MBS session join response message. In some implementations, the UE 102A can include the first and second MBS session IDs in an MBS session join request message (e.g., the first MBS session join request message) to request to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management (5GSM) messages. In the case of the 5GSM messages, the UE 102A can transmit to the CN 110 via the base station 104 a (first) UL container message including the MBS session join request message, the CN 110 can transmit to the UE 102A via the base station 104 a DL container message including the MBS session join response message, and the UE 102A can transmit to the CN 110 via the base station 104 a (second) UL container message including the MBS session join complete message. These container messages can alternatively be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can also represent their respective container messages.

In some implementations, the UE 102A can perform (not shown) a PDU session establishment procedure with the CN 110 via the base station 104 to establish a PDU session in order to perform the (first) MBS session join procedure. During the PDU session establishment procedure, the UE 102A can communicate a PDU session ID of the PDU session with the CN 110 via the base station 104.

Before, during, or after the (first) MBS session join procedure (event 502), the CN 110 can send 504 a (first) CN-to-BS message including the first MBS session ID and/or PDU session ID to the CU 172 to request the CU 172 to configure resources for the first MBS session. In response to receiving 504 the first CN-to-BS message, the CU 172 sends 506 a CU-to-DU message to the DU 174 to request a set-up for an MBS context and/or a common DL tunnel for the first MBS session. In response to receiving 506 the CU-to-DU message, the DU 174 sends 508, to the CU 172, a DU-to-CU message including a first DU DL transport layer configuration to configure a common CU-to-DU DL tunnel for the first MBS session (e.g., for a MRB identified by one of the MRB ID(s)). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QoS) configuration(s) for the first MBS session in the first CN-to-BS message. In such cases, the CU 172 can include the QoS configuration(s) in the CU-to-DU message (event 506).

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer address (e.g., an IP address and/or a TEID) to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

The events 504, 506, 508, and 510 are collectively referred to in FIG. 5A as an MBS session resource setup procedure 586.

In cases where the CN 110 grants the additional MBS session(s) for the UE 102A in the additional MBS session join procedure(s), the CN 110 can include the additional MBS session ID(s) and, optionally, QoS configuration(s) for the additional MBS session ID(s) in the first CN-to-BS message, a subsequent CN-to-BS message, or additional CN-to-BS message(s) similar to the first or subsequent CN-to-BS message. In such cases, the CU 172 includes additional transport layer configuration(s) for the additional MBS session(s) to configure additional common DL tunnel(s) in the first BS-to-CN message, a subsequent BS-to-CN message, or additional BS-to-CN message(s) similar to the first or subsequent BS-to-CN message. Each of the transport layer configuration(s) configures a particular common DL tunnel of the common DL tunnel(s) and can be associated to a particular MBS session of the additional MBS session(s). Alternatively, the CN 110 can perform additional MBS session resource setup procedure(s) with the CU 172 to obtain the additional transport layer configuration(s) from the CU 172, similar to the single-session MBS session resource setup procedure 586 shown in FIG. 5A. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 can indicate, in the first CN-to-BS message, a list of UEs joining the first MBS session. In other implementations, the CN 110 can send 512 to the CU 172 a second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message 512. In such cases, the second CN-to-BS message can be a non-UE-specific message, i.e., a message not specific for the UE 102A or the UE 102B. The CU 172 can include the first MBS session ID and/or the PDU session ID in the second BS-to-CN message. For example, the list of UEs includes the UE 102A and/or UE 102B. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends 512 the list of (CN UE interface ID, RAN UE interface ID) pairs in the second CN-to-BS message, the CU 172 sends (not shown) a BS-to-CN message (e.g., a NGAP message, an INITIAL UE MESSAGE or PATH SWITCH REQUEST message) including the RAN UE interface ID to the CN 110 for each of the UEs, and the CN 110 sends (not shown) a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be an “AMF UE NGAP ID” and the “RAN UE interface ID” can be a “RAN UE NGAP ID”. In other implementations, the CN 110 can include a list of UE IDs each identifying a particular UE of the UEs. In some implementations (not shown), the CN 110 can assign the UE IDs and send each of the UE IDs to a particular UE of the UEs in a NAS procedure (e.g., a registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends 512 the list of UE IDs, the CU 172 can receive (not shown) the UE ID from the UE 102 or the CN 110 for each of the UEs. For example, the CU 172 can receive (not shown) a RRC message (e.g., an RRCSetupComplete message) including the UE ID from the UE 102 during a RRC connection establishment procedure. In another example, the CU 172 can receive (not shown) a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102 (e.g., either the UE 102A or the UE 102B) that joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102A to receive MBS data of the first MBS session. In some implementations, the CU 172 can include QoS configuration(s) in the UE Context Request message. In such cases, the CU 172 might or might not include the QoS configuration(s) in the CU-to-DU message sent 506 during the MBS session resource setup procedure 586. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters can include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively. In some implementations, the second CN-to-BS message and the second BS-to-CN message can be UE-associated messages, i.e., the messages are associated to a particular UE (e.g., the UE 102A or 102B).

In cases where the CN 110 grants the additional MBS session(s) for the UE 102A in the additional MBS session join procedure(s), the CN 110 can include the additional MBS session ID(s) and/or QoS configuration(s) for the additional MBS session ID(s) in the first CN-to-BS message or the second CN-to-BS message. In such cases, the CU 172 can include the additional MBS session ID(s) and MRB ID(s) in the CU-to-DU message, and the DU 174 include, in the DU-to-CU message, additional DU transport layer configuration(s) to configure additional CN-to-BS DL tunnel(s) for the additional MBS session(s). Alternatively, the CU 172 can perform additional MBS session resource setup procedure(s) with the DU 174 to obtain the additional DU DL transport layer configuration(s), similar to the events 506 and 508. In some implementations, the CU 172 includes, in the first BS-to-CN message, additional CU DL transport layer configuration(s) for the additional MBS session(s) to configure additional CN-to-BS common DL tunnel(s). Each of the transport layer configuration(s) configures a particular DL tunnel of the common CN-to-BS DL tunnel(s) and can be associated to a particular MBS session of the additional MBS session(s). Alternatively, the CN 110 can perform additional MBS session resource setup procedure(s) with the CU 172 to obtain the additional CU DL transport layer configuration(s) from the CU 172, similar to the MBS session resource setup procedure 586. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102A to receive MBS data of the first MBS session in response receiving 506 the CU-to-DU message or receiving 514 the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) neither in the CU-to-DU message nor the UE Context Request message, the DU 174 can determine values of the configuration parameters in accordance with a predetermined (default) QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations and transmits 518 the RRC reconfiguration message to the DU 174. In turn, the DU 174 transmits 520 the RRC reconfiguration message to the UE 102. The UE 102 then transmits 522 a RRC reconfiguration complete message to the DU 174, which in turn transmits 523 the RRC reconfiguration complete message to the CU 172.

The events 512, 514, 516, 518, 519, 520, 522 and 523 are collectively referred to in FIG. 5A as an MBS radio connection reconfiguration procedure 588. The events 514, 516, 518, 520, 522 and 523 are collectively referred to in FIG. 5A as an MBS radio connection reconfiguration procedure 589.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B, and PHY layer 202B. The UE 102 receives 520 the PDCP PDU from the DU 174 via the PHY layer 202B, MAC layer 204B and RLC layer 206B. In some implementations, the UE 102 generates a PDCP PDU including the RRC reconfiguration complete message and transmits 522 the PDCP PDU to the DU 174 via the RLC layer 206B, MAC layer 204B, and PHY layer 202B. The DU 174 receives 522 the PDCP PDU from the UE 102 via the PHY layer 202B, MAC layer 204B, and RLC layer 206B and sends 523 a DU-to-CU message including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

In some implementations, respective instances of the MBS radio connection reconfiguration procedure 588 occur for each of the UE 102A and the UE 102B. The configuration parameters for the UE 102A and the UE 102B to receive MBS data of the first MBS session can be the same.

In some implementations, the CU 172 includes the CU DL transport layer configuration(s) in the second BS-to-CN message and/or a subsequent BS-to-CN message. In other words, the CU 172 can send the same CU DL transport layer configuration(s) in BS-to-CN messages in responses to CN-to-BS messages indicating UEs joining the same MBS session. In such implementations, the CN 110 can blend the MBS resource setup procedure 586 and the MBS radio connection reconfiguration procedure 588 into a single procedure.

In cases where the CU 172 performs the MBS resource setup procedure 586 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure 586 (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

After receiving 510 the first BS-to-CN message or receiving 519 the second BS-to-CN message, the CN 110 can send 524 MBS data (e.g., one or multiple MBS data packets, also interchangeably referred to herein as “MBS content data” or “MBS payload data”) to the CU 172 via the common CN-to-BS DL tunnel, which in turn sends the 526 the MBS data to the DU 174 via the common CU-to-DU tunnel. The DU 174 transmits (e.g., multicast or unicast) 528 the MBS data via the one or more logical channels to the UE 102 (i.e., the UE 102A and the UE 102B). The UE 102 receives 528 the MBS data via the one or more logical channels. For example, the CU 172 receives 524 an MBS data packet, generates a PDCP PDU including the MBS data packet and transmits 526 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration.

In some implementations, the CU 172 can (determine to) configure a UE-specific CN-to-BS DL tunnel for the UE 102 in response to receiving 504 the first CN-to-BS message or receiving 512 the second CN-to-BS message. In such cases, the CU 172 can omit the event 506, and can include, in the second BS-to-CN message, a DL transport layer configuration configuring a UE-specific DL tunnel. The CN 110 can transmit 524 the MBS data to the CU 172 via the UE-specific CN-to-BS DL tunnel. In some implementations, the CU 172 can (determine to) configure a UE-specific CU-to-DU DL tunnel for the UE 102 in response to receiving 504 the first CN-to-BS message or receiving 512 the second CN-to-BS message. In such cases, the CU 172 can omit the event 510 and the DU 174 can include, in the UE Context Response message, a DL transport layer configuration configuring a UE-specific CU-to-DU DL tunnel. In such cases, the CU 174 can transmit 526 the MBS data to the DU 174 via the UE-specific CU-to-DU DL tunnel.

In some implementations, the one or more MRB configurations configuring one or more MRBs are associated with the first MBS session. In some implementations, the configuration parameters also include one or more RLC bearer configurations, each associated with a particular MRB. Each of the MRB configuration(s) can include a MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring configure the logical channel. In some implementations, the RLC bearer configuration may include the MRB ID.

In some implementations, the CU 172 can configure the MRB as a DL-only RB in the MRB configuration. For example, the CU 172 refrains from including UL configuration parameters in the PDCP configuration within the MRB configuration to configure the MRB as a DL only RB. The CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de)compression protocol (e.g., robust header compression (ROHC) protocol), e.g., in the MRB configuration. In this case, when the CU 172 receives 524 an MBS data packet from the CN 110, the CU 172 compresses the MBS data packet with the compression protocol to obtain a compressed MBS data packet and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet with the (de)compression protocol to obtain the original MBS data packet. In such cases, the UE 102 may transmit a PDCP Control PDU including, a header compression protocol feedback (e.g., interspersed ROHC feedback) for operation of the header (de)compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). A MRB ID identifies a particular MRB of the MRB(s). The base station 104 set the MRB IDs to different values. In cases where the CU 172 has configured DRB(s) to the UE 102 for unicast data communication, the CU 172 in some implementations can set one or more of the MRB ID(s) to values different from DRB ID(s) of the DRB(s). In such cases, the UE 102 and the CU 172 can distinguish whether an RB is a MRB or DRB in accordance an RB ID of the RB. In other implementations, the CU 172 can set one or more of the MRB ID(s) to values which can be the same as the DRB ID(s). In such cases, the UE 102 and the CU 172 can distinguish whether an RB is a MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU 172 can determine an RB is a DRB if the CU 172 transmits a DRB-ToAddMod IE configuring the RB to the UE 102, and determine an RB is an MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters may or may not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message, or any suitable RRC message that can include a UL NAS PDU.

With continued reference to FIG. 5A, the UE 102B can perform 530 an MBS session join procedure similar to the procedure 502 discussed above. The UE 102B can perform a PDU session establishment procedure with the CN 110 via the base station 104 as described with reference to procedure 502. The UE 102B can communicate a PDU session ID with the CN 110 in the PDU session establishment procedure. The UE 102B can join the same MBS session as the UE 102A by sending an MBS session join request and specifying the same MBS session ID. In this example scenario, the UE 102B joins the MBS session after the base station 104 has started transmitting 528 MBS data packets to the UE 102A. The CN 110 transmits 532, to the CU 172, a CN-to-BS message including the MBS session ID and/or the PDU session ID in order to indicate that the UE 102B should start receiving MBS data for an MBS session corresponding to the MBS session ID.

In some scenarios, the CU 172 or CN 110 determines that a DL tunnel for the MBS session identified in the event 532 already exists, and that there is no need to perform the procedure 586. Optionally, however, the CU 172 sends 534 a CU-to-DU message to the DU 174 to trigger an MBS radio connection reconfiguration procedure for the first MBS session similar to event 589, and the DU 174 responds 536 with a DU configuration.

The CU 172 transmits 538 an RRC reconfiguration message to the DU 174, and the DU 174 transmits 540 the RRC reconfiguration message to the UE 102B to configure the UE 102B to receive the MBS traffic. The RRC reconfiguration message can include the same LCID (value), MRB configuration, and RLC bearer configuration as the event 520, when the UEs 102A and 102B operate in the same cell. When the UEs 102A and 102B operate in different cells, the RRC reconfiguration message can have a different G-RNTI, LCID, and/or RLC bearer configuration, for example. The RRC reconfiguration message can include the same MRB configuration as the event 520, when the UEs 102A and 102B operate in different cells. As illustrated in FIG. 3, the CU 172 can map data packets arriving via the common CN-to-BS DL tunnel to one or more MRBs, each corresponding to a common CU-to-DU DL tunnel and/or a respective logical channel.

The UE 102B transmits 542 an RRC reconfiguration complete message(s) (e.g., RRCReconfigurationComplete message(s)) to the base station 104 in response to the RRC reconfiguration message(s) of event 540, which can be received 542 by the DU 174. In response to the DU 174 of the base station 104 receiving 542 the RRC reconfiguration complete message, the DU 174 transmits 543 an RRC reconfiguration complete message to the CU 172. Before or after receiving 542 the RRC reconfiguration complete message(s), the base station 104 in some cases sends 539 another BS-to-CN message to the CN 110, e.g., in a manner generally similar to the event 519. The BS-to-CN message can indicate an updated list of UEs associated with the MBS session specified in the event 532, for example. After the UE 102B has joined 530 the MBS session and obtained 540 the necessary RRC configuration, the CU 172 continues to receive 544 MBS data via the common CN-to-BS DL tunnel and transmits 546 the MBS data to the DU 174 via the common CU-to-DU DL tunnel. In some implementations, the DU 174 transmits 548 the MBS data to the UE 102A and UE 102B via multicast. The UE 102A and UE 102B can receive 548 MBS data similar to event 528. Alternatively, the base station 104 can transmit 548 the MBS data to the UE 102A and UE 102B separately via unicast.

Referring next to FIG. 5B, a scenario 500B is depicted which is generally similar to the scenario 500A. Events in this scenario similar to those discussed above are labeled with the same reference numbers and the examples and implementations for FIG. 5A can apply to FIG. 5B. The differences between the scenarios of FIG. 5A and FIG. 5B are discussed below.

In some implementations, the CU 172 can perform an MBS session resource setup procedure and UE-specific MBS session configuration procedure 587 (e.g., a combination of events 586 and 589) with the CN 110 in response to receiving 512 the second CN-to-BS message specifying the UE ID and a session ID for UE 102A. In such implementations, the CU 172 transmits 510 the first BS-to-CN message to the CN 110 in response to receiving 512 the second CN-to-BS message. Then, the CN 110 transmits 504 the first CN-to-BS message to the CU 172 in response to receiving 510 the first BS-to-CN message. In such cases, the CN 110 may or may not include an MBS session ID (i.e., the first MBS session ID) in the first CN-to-BS message. The CN 110 can transmit 519 the second BS-to-CN message in response to or after receiving 512 the second CN-to-BS message or receiving 504 the first CN-to-BS message. After or in response to receiving 512 the second CN-to-BS message, transmitting 510 the first BS-to-CN message, or receiving 504 the first CN-to-BS message, the CU 172 can transmit 506 the CU-to-DU message to the DU 174.

Instead of the CU 172 transmitting 506 the CU-to-DU message to request to configure a common CU-to-DU DL tunnel, the DU 174 in some implementations can transmit 508 the DU-to-CU message in response to receiving 514 the UE Context Request message in addition to transmitting 516 the UE Context Response message. Then, the CU 172 can send 508 a CU-to-DU response message to the DU 174 in response to receiving 506 the DU-to-CU message. In such cases, the DU-to-CU message and the CU-to-DU response message can be non-UE associated messages, i.e., the messages are not associated to a particular UE.

Thus, the events 512, 510, 504, 506, 508, 514, 516, 518, 519, 520, 522 and 523 are collectively referred to in FIG. 5B as an MBS resource setup and UE-specific MBS session configuration procedure 587. In cases where the CN 110 grants the additional MBS session(s) for the UE 102A in the additional MBS session join procedure(s), the CN 110 can perform MBS resource setup and UE-specific MBS session configuration procedure(s) with the base station 104 and UE 102A, similar to the procedure 587. In such cases, the CN 110 can include the additional MBS session ID(s) and, optionally, QoS configuration(s) for the additional MBS session ID(s) in CN-to-BS message(s) in the MBS resource setup and UE-specific MBS session configuration procedure(s), similar to the first or second CN-to-BS message. In such cases, the CU 172 includes additional transport layer configuration(s) for the additional MBS session(s) to configure additional common DL tunnel(s) in BS-to-CN message(s) in the MBS resource setup and UE-specific MBS session configuration procedure(s), similar to the first or second BS-to-CN message. Each of the transport layer configuration(s) configures a particular common DL tunnel of the common DL tunnel(s) and can be associated to a particular MBS session of the additional MBS session(s). The transport layer configurations can be different to distinguish between different common DL tunnels. In particular, any pair of the transport layer configurations can have different IP addresses, different DL TEIDs, or different IP addresses as well as different DL TEIDs.

A UE that is receiving or interested in receiving an MBS can transmit an MBS interest indication to a network (e.g., to a CN 110). Based on the MBS interest indication, the network attempts to enable the UE to receive MBS and unicast services subject to the capabilities of the UE, e.g., the radio capabilities of the UE. In the MBS interest indication, the UE can indicate a set of frequencies (including one or more frequencies) where the UE is receiving or is interested in receiving MBS. The MBS interest indication can also indicate a list of MBS services that the UE is receiving or is interested in receiving on the indicated one or more frequencies. Further, the UE can transmit the MBS interest indication regardless of whether the serving cell supports MBS. In some cases, the UE can send a first MBS interest indication to the network, and send a second, updated MBS interest indication at a later time.

Generally speaking, a UE and/or a RAN manage information related to multicast and/or broadcast services (MBS). A UE, for example, can transmit to the RAN an MBS interest indication that indicates a configuration according to which the UE prefers to receive an MBS transmission (e.g., an “MBS interest configuration”). The MBS interest configuration may include a set of frequencies where the UE is receiving or is interested in receiving MBS and a list of MBS services that the UE is receiving or is interested in receiving on the indicated frequencies. In response to determining that a radio connection between the UE and the RAN is to be modified, the UE can determine to either retain or release the MBS interest configuration. If the UE retains the MBS interest configuration, the UE can later transmit an MBS interest indication update to the RAN. If the UE releases the MBS interest configuration, the UE may transmit another MBS interest indication to the RAN after modifying the radio connection.

Likewise, a node of the RAN can also receive an MBS interest indication from the UE, and either retain or release the configuration included in the MBS interest indication in response to determining that a radio connection between the UE and the RAN is to be modified. Trigger events that can cause the UE and/or the RAN to determine to release or retain the MBS interest indication include the UE detecting a failure on the radio connection, or the UE suspending, resuming, or reestablishing the radio connection with the RAN.

Further, MBS interest configurations can be stored at the receiving RAN node, at other RAN nodes, and/or at one or more CNs of the wireless communication system. For example, the RAN node receiving an MBS interest configuration from a UE can forward the received UE MBS interest configuration to another RAN node, to the CN, etc., any of which can forward the UE MBS interest configuration to other RAN nodes and/or CNs.

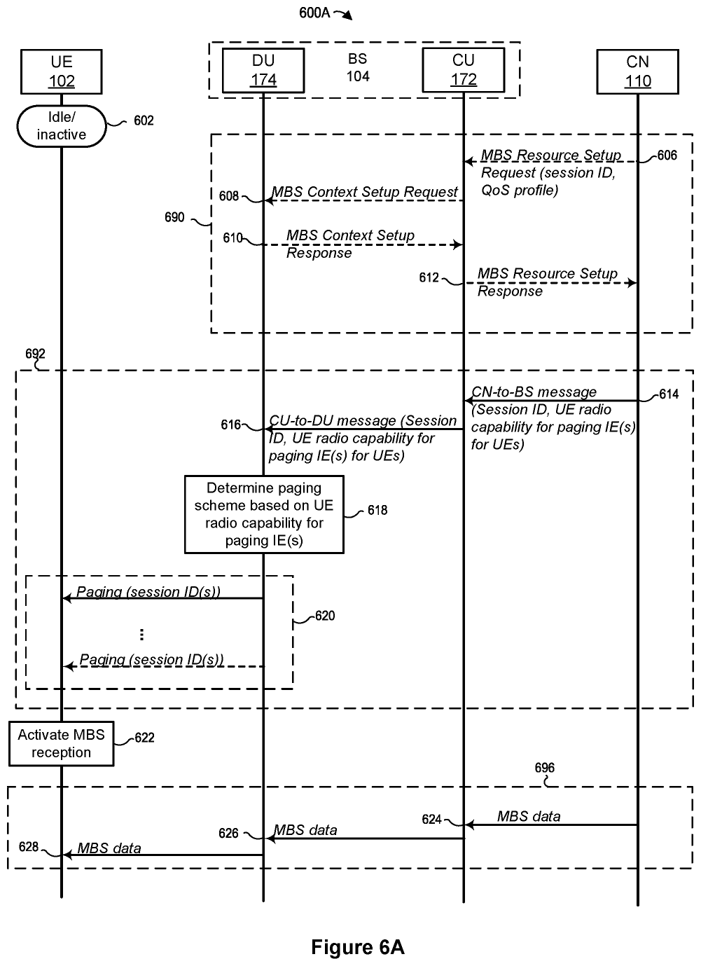

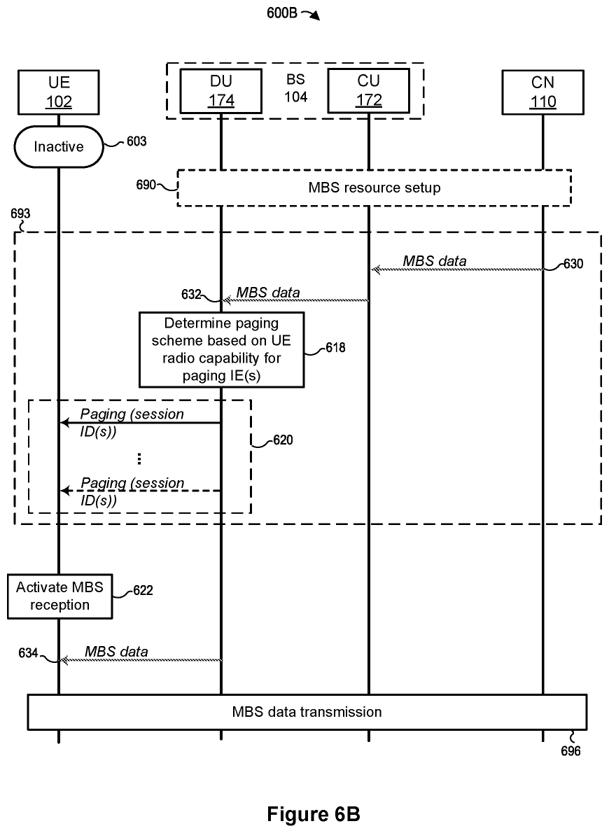

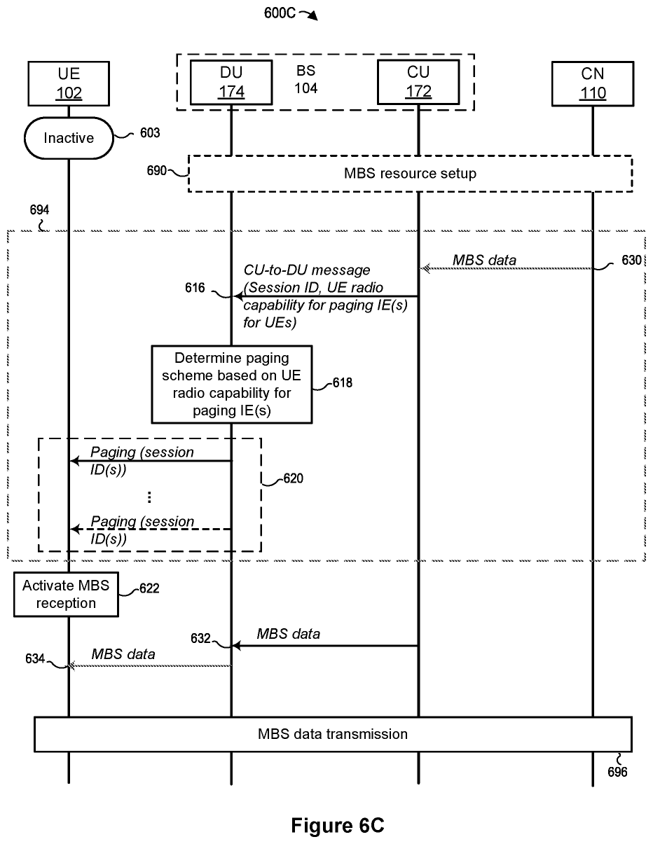

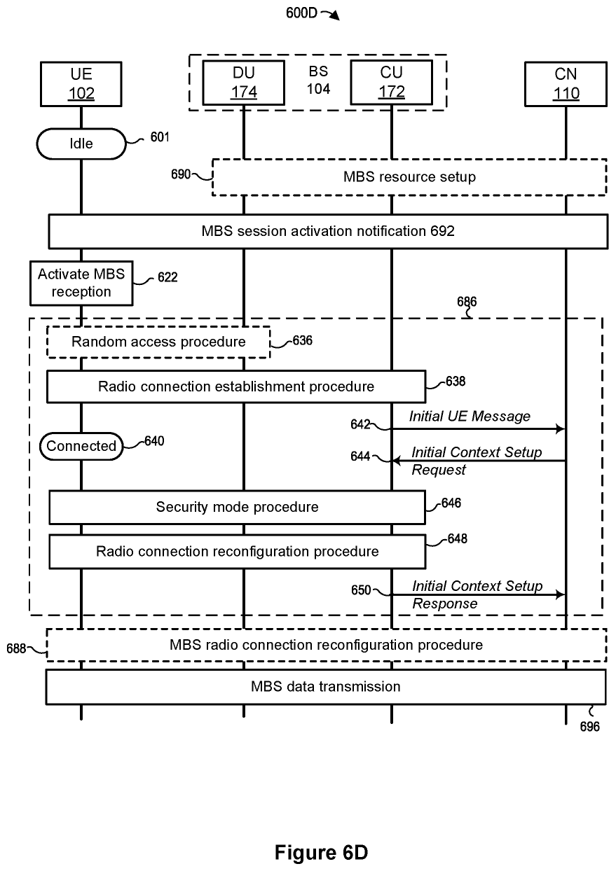

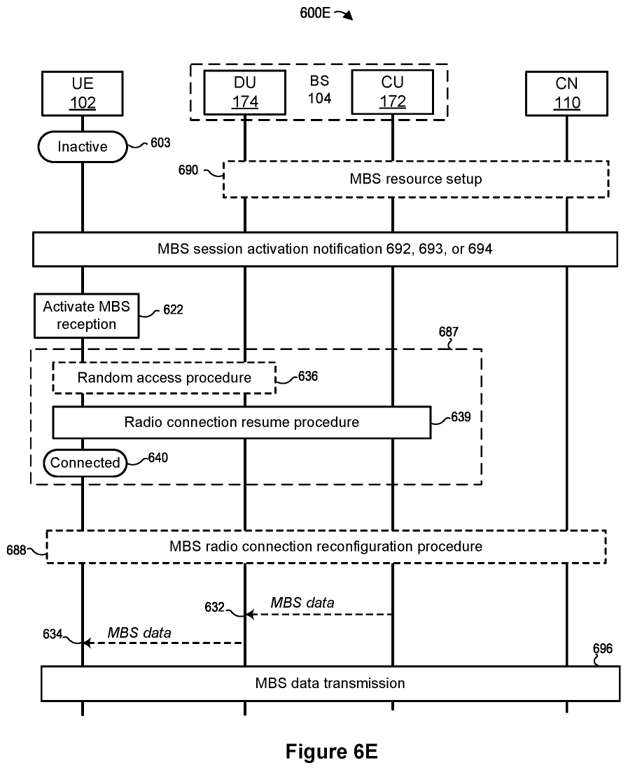

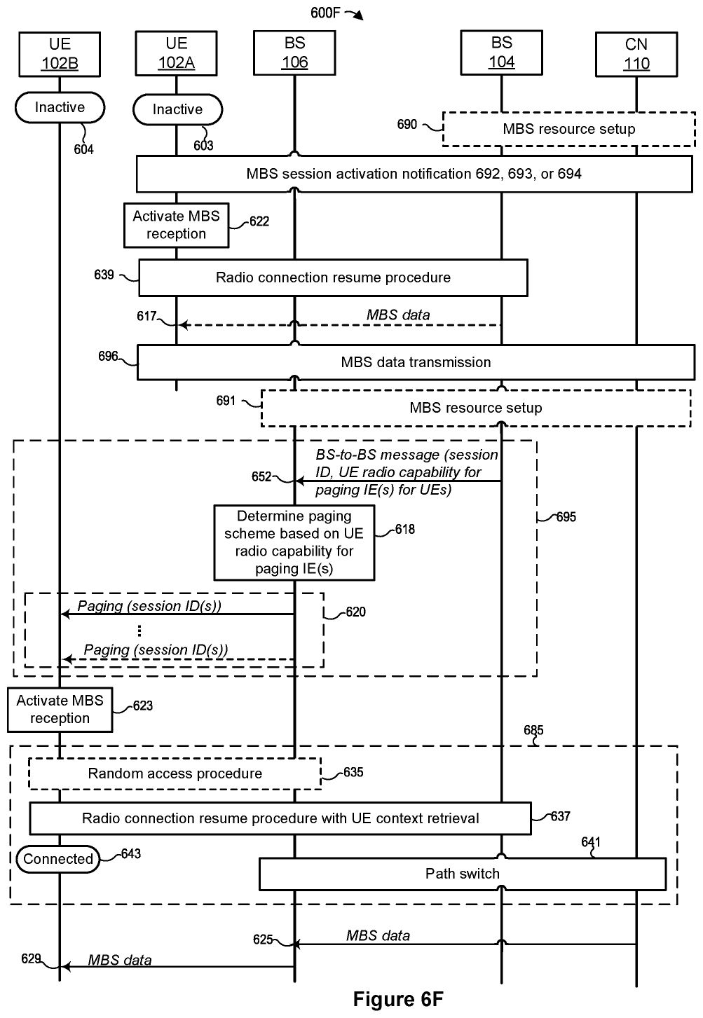

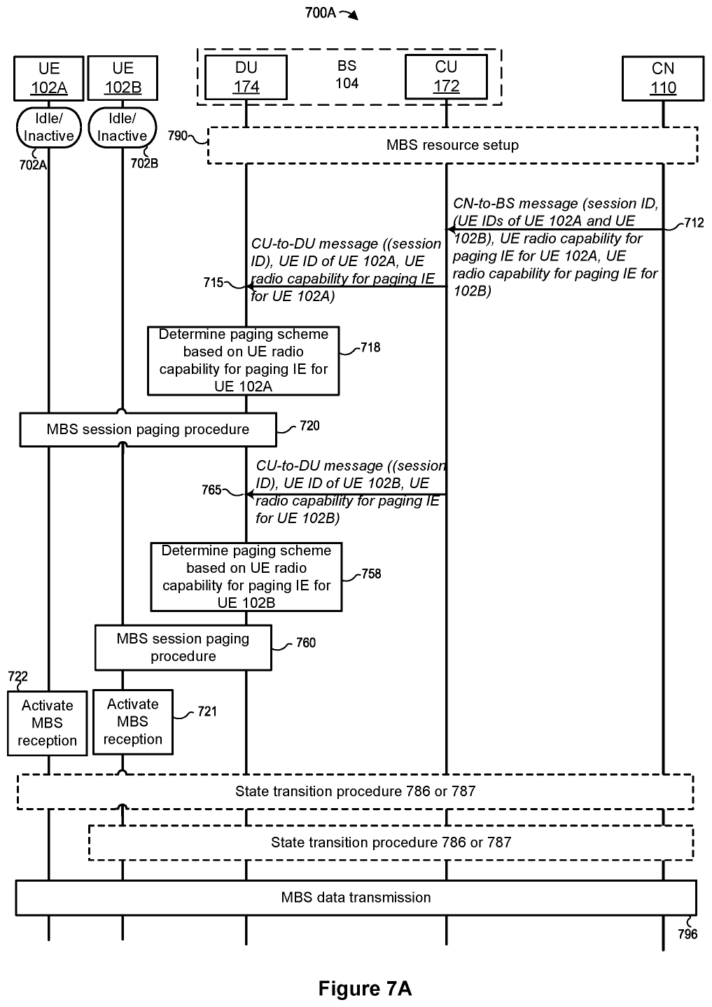

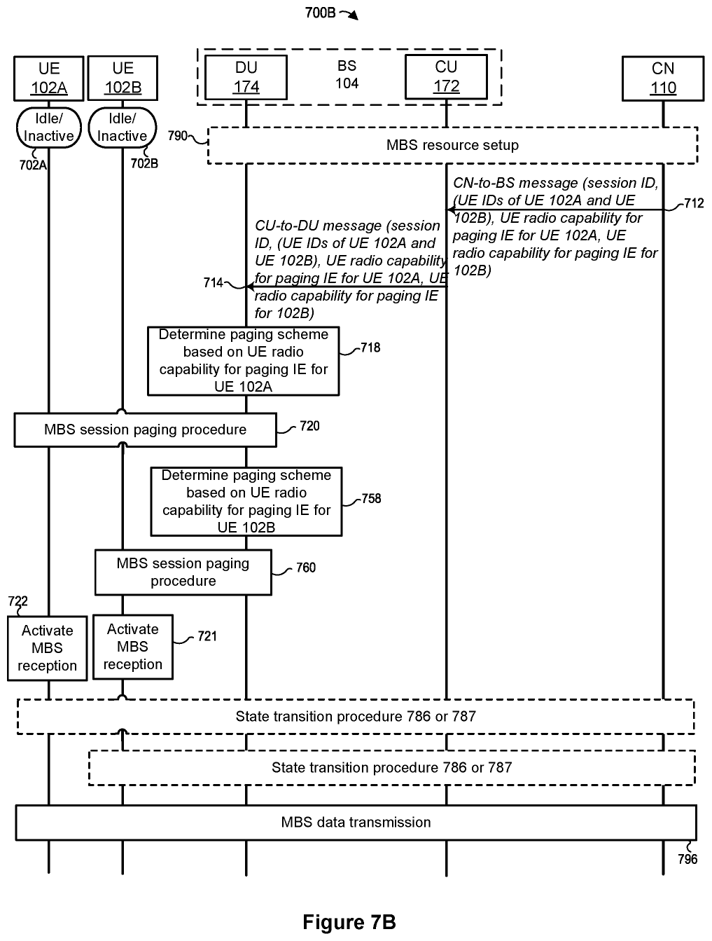

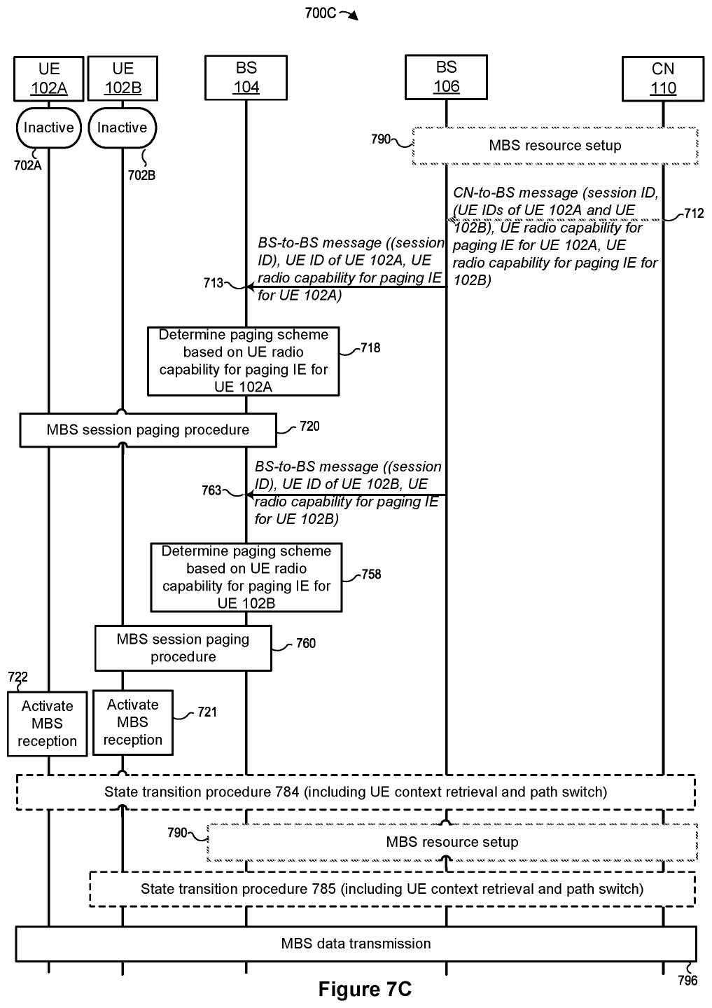

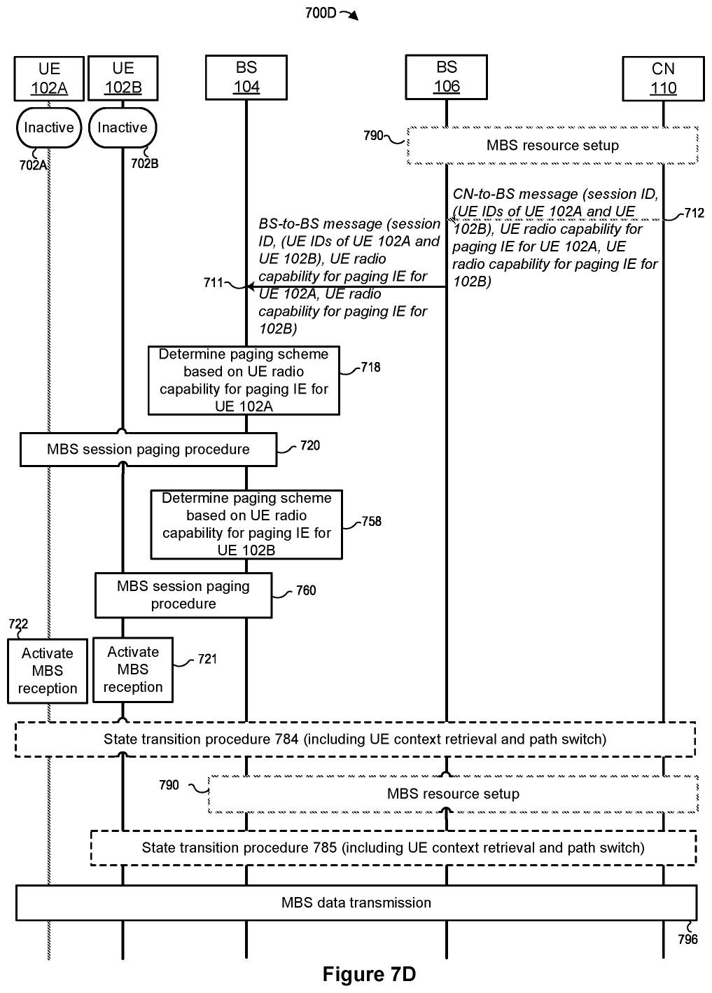

Next, several example scenarios in which devices illustrated in FIGS. 1A-5B can participate in are discussed with reference to FIGS. 6A-6F and 7A-7D.

FIG. 6A illustrates an example scenario 600A, which can occur in the wireless communication system 100, in which the CN 110 requests the BS 104 to page UEs that had previously indicated an interest in a particular MBS service. Generally, the CN 110 transmits, to the CU 172 of the BS 104, a single, first multicast paging message 614 instructing the BS 104 to page a group of UEs that have previously indicated an interest in the MBS service and that are operating in an idle or inactive state. In turn, the CU 172 transmits a corresponding, single second multicast paging message 616 indicating the group of UEs to a DU 174 of the BS 104, and the DU 174 pages 620 one or more UEs (including UE 102) that are interested in the MBS service while the UEs are operating in an idle state or an inactive state 602 to thereby activate MBS data reception 622 for the MBS service at the UEs without the UEs changing state, e.g., as described in more detail below.

As initially shown in FIG. 6A, the CN 110 and the BS 104 can perform an MBS session resource setup procedure 690 prepare, configure, reserve, and/or otherwise set up resources of the BS 104 for supporting the delivery of content data of the MBS service via the common DL tunnel and MBS session of the MBS service to interested UEs associated with the BS 104. Generally speaking, the MBS session resources set up procedure 690 may be similar to the MBS session resource setup procedure 586 of FIG. 5A. For example, as part of the MBS session resource setup procedure 690, the CN 110 can send 606 a CN-to-BS message (e.g., an MBS Session Resource Setup Request message) to the base station 104, where the message 606 includes the MBS session ID of the MBS service and, in some cases, a corresponding QoS profile, thereby requesting the base station 104 to reserve and configure resources for the MBS service. In response to receiving 606 the CN-to-BS message, the CU 172 sends 608 a CU-to-DU message (e.g., an MBS Context Setup Request) to request the DU 174 to setup (e.g., prepare, configure, reserve, and/or otherwise setup resources) for the MBS context and/or the common DL tunnel for the MBS session indicated in the MBS Resource Setup Request. The DU 174 transmits 610 a corresponding response (e.g., an MBS Context Setup Response message) indicating the resources that the DU 174 has prepared for the MBS session of the MBS service, such as a DU transport layer configuration. In turn, the CU 172 sends 612 a BS-to-CN message (e.g., an MBS Session Resource Setup Response message) that includes a DL transport layer configuration for the CN 100 use in configuring a common DL tunnel via which the CN 110 can send MBS data to the base station 104. The DL transport layer configuration includes a transport layer address (e.g., an IP address and/or a TEID) to identify the common DL tunnel, for example.

The events 606, 608, 610, and 612 are collectively referred to in FIG. 6A as an MBS session resource setup procedure 690.

Next, as shown in the scenario 600A of FIG. 6A, the CN 110, BS 104, and UE 102 can perform an MBS session activation procedure 692 via which the BS 104 (and specifically, the DU 174 of the BS 104) pages the UE 102 (and, in some cases, other interested UEs operating in the idle or inactive state) for the MBS service, and the UE 102 activates 622 for reception of MBS content data. For example, the CN 110 can send 614 a CN-to-BS message, where the message is a single (e.g., one and only one) message that includes multicast or group paging instructions for a set of one or more (but typically multiple or a group of) UEs that are interested in the MBS service and operating in an idle or inactive state, and that are to be paged for the MBS service. Such a message sent at the event 614 is generally referred to within this document as a “group paging message” or a “multicast paging message.” In some implementations, the group paging message or multicast paging message for event 614 is the Multicast Group Paging message defined for 3GPP TS 38.413 NGAP. The single, multicast paging message includes the MBS session ID, an indication of the identifications of UEs that have previously indicated an interest in the MBS service, and optionally an indication of respective UE radio capabilities of the interested UEs, service areas of the MBS service, and possibly other information, if desired. For instance, the CN-to-BS message sent at event 614 can identify interested UEs via respective specific and/or derived paging identities or by some other suitable format of identification, e.g., similar to UE identification formats previously discussed with respect to event 512 of FIG. 5A (such as a pairing of (CN UE interface ID/RAN UE interface ID), S-TMSI, etc.). Accordingly, the single multicast paging message can indicate, by using only a single message, multiple UEs which are to be paged for the MBS service as well as the MBS session ID which each UE of the multiple UEs can utilize to receive content data of the MBS service, e.g., via the common tunnel which was set up in procedure 690.

In some situations, the CN 110 stores an indication of respective radio capabilities of UEs and the CN 110 can include, within the multicast paging message sent at event 614, an indication of the respective UE radio capabilities of interested UEs, such as respective UERadioPagingInformation IEs, other indications of respective radio capabilities of paging Information Elements (IEs), capability IEs of UEs, etc. The indicated respective UE radio capabilities can include, for example, respective supported time domain resources, supported frequency domain resources (e.g., supported bands, such as supported NR bands), supported modulation scheme(s), support for a wake-up signal, support for paging early indication, supported downlink schedule offset(s) for one or more types and or more frequency range (such as discontinuous reception (DRX) cycle configuration), and/other types of UE-specific radio capability information. For example, the information of downlink scheduling offset can include dl-SchedulingOffset-PDSCH-TypeA-FDD-FR1, dl-SchedulingOffset-PDSCH-TypeA-TDD-FR1, dl-SchedulingOffset-PDSCH-TypeA-TDD-FR2, dl-SchedulingOffset-PDSCH-TypeB-FDD-FR1, dl-SchedulingOffset-PDSCH-TypeB-TDD-FR1, and/or dl-SchedulingOffset-PDSCH-TypeB-TDD-FR2.

In some situations, though, such as when at least some of UE radio capability information has been previously stored at the CU 172 and/or at the DU 174, (and as this document discusses elsewhere with respect to other example scenarios), UE radio capability information can be excluded from the multicast paging message sent by the CN 110 at event 614.

At any rate, upon receiving the single, multicast paging message from the CN 110, the CU 172 reserves and/or otherwise sets up its internal resources for supporting the MBS service, and subsequently generates and sends 616 one or more CU-to-DU messages, e.g., a second, single multicast paging message, to one or more DUs 174. For example, the CU 172 can maintain a list or other indication of the UEs which are operating in an inactive state and/or in an idle state and associated with the base station 104, and the CU 172 can filter the list to determine a set of UEs that are operating in the idle or inactive state, associated with the base station 104, and interested in the MBS service (e.g., as was indicated by the CN-to-BS message received at event 614). The CU 172 can generate and send 616 the second, single multicast paging message to one or more DUs 174, where the second, single multicast paging message includes the MBS session ID, an indication of the identifications of filtered set of UEs that are associated with the base station 104 and that have previously indicated an interest in the MBS service, and optionally UE radio capabilities information and/or other information, e.g., in a manner similar to that described above for the single multicast paging message sent at the event 614. In some embodiments, such as when the BS 104 includes multiple DUs 174 and the CU 172 maintains an indication of which UEs are presently associated with which particular DUs 174, the CU 172 can additionally filter the set of interested UEs which are operating in the inactive or idle state on a per-DU basis, and send 616 an indication of only the respective subset of interested UEs associated with each DU in each CU-to-DU group multicast paging message.

Upon receiving 616 the CU-to-DU message instructing the DU 174 to page the indicated UEs for the MBS service, the DU 174 can determine 618 respective paging schemes for each indicated UE, e.g., based on the respective radio capabilities of each indicated UE. In some situations, such as when the received paging instructions 616 include an indication of the respective radio capabilities of each indicated UE, the DU 174 can page 620 each indicated UE in accordance with the received respective UE radio capabilities indicated in the paging instructions at the event 616. Additionally or alternatively, in some situations, the DU 174 has previously stored indications of respective radio capabilities of at least some of the indicated UEs, and the DU 174 can page 620 each of the at least some of the UEs indicated in the second multicast paging message in accordance with the respective, previously-stored indications. Significantly, though, and as shown in the scenario 600A, the DU 174 includes 620 the MBS session ID in each UE paging message, so that a recipient UE can utilize the MBS session ID to join and use the tunnel established for the MBS service. That is, each UE paging message includes the information the recipient UE uses for activating itself for receiving 622 content data of the MBS service via the MBS session.

The events 614, 616, 628, and 620 are collectively referred to in FIG. 6A as an MBS session activation procedure 692.

At the UE 102 operating in the idle or inactive state 602, the UE 102 activates for receiving MBS content data of the MBS session. For example, the UE 102 can perform an MBS session join procedure, such as the MBS session join procedure 502 or 530, thereby joining the MBS session of the MBS service and communicatively connecting to the common DL tunnel for the MBS service. Accordingly, via the common DL tunnel, the CN 110 can transmit 624 content data of the MBS service to the CU 172, the CU 172 can transmit or forward 626 the received MBS content data to the DU 174, and the DU 174 can transmit or forward 628 the received MBS content data to the activated UE 102.

Collectively, the transmission of MBS content data from the CN 110 to the UE 102 via the established common DL tunnel (e.g., the collection of the events 624, 626, 628) is referred to in FIG. 6A as an MBS content data delivery procedure 696. Further, in the scenario 600A, the UE 102 does not change its operational state for receiving MBS content data. That is, the UE 102 can maintain its operation state as idle or inactive 602 while activating 622 for MBS content data reception and while receiving 628 MBS data.

FIG. 6B illustrates an example scenario 600B, which can occur in the wireless communication system 100, in which the CN 110 transmits 630 content data of an MBS service to the CU 172 of the BS 104, the CU 172 transmits or forwards 632 the received MBS content data to the DU 174 of the BS 104, and the DU 174 pages 620 one or more interested UEs 102 for the MBS service. At least some of the scenario 600B is generally similar to the scenario 600A, and accordingly, events in scenario 600B similar to those discussed above for scenario 600A are labeled with the same reference numbers and similar examples and implementations for FIG. 6A can apply to FIG. 6B. The differences between the scenarios of FIG. 6A and FIG. 6B are discussed below.

As shown in the scenario 600B, a UE 102 which is interested in the MBS service is operating in an inactive state 603. At some point in time, the CN 110 and the BS 104 perform an MBS session resource setup procedure 690 to configure resources to support the common DL tunnel via which content data of the MBS service is to be delivered to interested UEs as well as set up other necessary resources. For example, prior to the UE 102 transitioning to operate in the inactive state 603 as shown in FIG. 6B, the CN 110 and the BS 104 may have performed the MBS session resource setup procedure 690 for the MBS service, the UE 102 may have joined the MBS session for the MBS service while the UE 102 was operating in the connected state, and the UE 102 may have been receiving MBS content data via the established common DL tunnel for the MBS service while operating in the connected state, e.g., in a manner similar to that shown in FIGS. 5A and 5B.

At any rate, in FIG. 6B, after the UE 102 has transitioned to operating in the inactive state 603, the CN 110 receives content data for the MBS service, and the CN 110 transmits 630 the received MBS content data to the CU 172 of the BS 104, e.g., via the common DL tunnel. Upon receiving 630 the MBS content data, the CU 172 transmits 632 the received MBS content data to one or more DUs 174, e.g., via the common DL tunnel. Upon receiving 632 the MBS content data, and as the UE 102 is operating in the inactive state 603 and its radio connection with the DU 174 is suspended, the DU 174 determines 618 a paging scheme for the UE 102, e.g., based on the radio capabilities of the UE 102. The DU 174 pages 620 the UE 102 in accordance with the UE's respective radio capabilities, where the paging message includes the MBS session ID. For example, the DU 174 can page the UE by transmitting 620 a paging message in accordance with the radio capabilities of the UE 102, where the paging message 620 indicates the MBS session ID. Further, as shown in the scenario 600B, when multiple UEs are operating in an inactive state 603 with respect to the DU 174, the DU 174 can determine 618 a respective paging scheme for each such UE, and the DU 174 can page 620 each such UE accordingly.

In the scenario 600B, the DU 174 has previously stored the radio capability information of the UE 102, e.g., based on the previously established radio connection of the UE 102 with the DU 174 via which the UE 102 was receiving MBS content data, or based on a previous connection attempt between the UE 102 and the BS 104 via the DU 174. Accordingly, in the scenario 600B, the CU 172 simply transmits or forwards 632 the received MBS content data to the DU 174, e.g., without sending any UE-specific radio capability information, and the DU 174 generates the paging message 620 for the UE 102 based on the UE's radio capability information stored at the DU 174.

The events 630, 632, 618, and 620 are collectively referred to in FIG. 6B as an MBS session activation procedure 693.

While the DU 174 is paging 620 the UE 102 operating in the inactive state 603 for the MBS service, the DU 174 can cache the MBS content data which the DU 174 received 632 from the CU 172. Upon successful paging 620 of the UE 102 and the UE 102 consequently (re)activating 622 MBS content data reception for the MBS service, the DU 174 can transmit 634 the cached MBS content data to the UE 102. Further, as the UE 102 (re)joins the MBS session upon (re)activation 622, the CN 110 can transmit 696 further MBS content data to the UE 102 via the common DL tunnel of the MBS service. Notably, in the scenario 600B, the UE 102 does not change its operational state for receiving MBS content data. That is, the UE 102 can maintain its operation state as inactive 603 while (re)activating 622 for MBS content data reception and while receiving 634, 696 MBS content data.

FIG. 6C illustrates an example scenario 600C, which can occur in the wireless communication system 100, in which the CN 110 transmits 630 content data of an MBS service to the CU 172 of the BS 104, the CU 172 transmits 616 a single, multicast paging message (indicating multiple interested UEs, including UE 102) to a DU 174 of the BS 104 and, based on the received 616 multicast paging message, the DU 174 pages 620 interested UEs (including UE 102) in the inactive state 603 for the MBS service. At least some of the scenario 600C is generally similar to scenario 600A and/or scenario 600B, and accordingly, events in scenario 600C similar to those discussed above for scenario 600A and/or for scenario 600B are labeled with the same reference numbers, and similar examples and implementations for FIGS. 6A and 6B can apply to FIG. 6C. The differences between the scenario 600C, 600B, and 600A are discussed below.

The scenario 600C occurs when the UE 102 is operating in the inactive state 603, similar to scenario 600B of FIG. 6B. However, in contrast to scenario 600B, in scenario 600C the CU 172 (and not the DU 174) has previously stored radio capability information for the UE 102, e.g., based on the UE's 102 previous connection (or attempt to connect) with the BS 104. As such, in the embodiment of the scenario 600C shown in FIG. 6C, upon the CU 172 receiving 630 content data of the MBS service, the CU 172 transmits 616, to the DU 174, a CU-to DU message that is a multicast paging message indicating the UE 102 and other interested UEs (e.g., multiple interested UEs) that are operating in the inactive state 603 with respect to the BS 104, where the multicast paging message includes the MBS session ID and an indication of the respective stored radio capability information of the indicated UEs. Additionally, while the DU 174 is performing the paging 620, the CU 172 can cache the MBS content data received 630 from the CN 110. Upon an interested UE 102 (re)activating 622 content data reception for the MBS service, the CU 172 can transmit 632 the cached MBS content data to the DU 174, and the DU 174 can transmit or forward 634 the received 632 MBS content data to the UE 102. In FIG. 6C, the UE 102 continues to operate in the inactive state 603 after (re)activation 622 of content data reception of the MBS service, and the UE 102 can receive 696 further MBS content data via the common DL tunnel.

The events 630, 616, 618, and 620 are collectively referred to in FIG. 6C as MBS session activation procedure 694.

In other embodiments of the scenario 600C (not shown), instead of transmitting 616 a multicast paging message to the DU 174, the CU 172 can transmit, to the DU 174, a respective unicast paging message for each interested UE operating in the inactive state 603 and associated with the DU 174. That is, each unicast paging message indicates one and only one UE that is to be paged for the MBS service, so that when multiple interested UEs are to be paged for the MBS service, the CU 172 transmits multiple, per-UE unicast paging messages to the DU 174. Each unicast paging message includes the MBS session ID and an indication of the radio capability information of the recipient UE (e.g., based on the stored UE radio capability information at the CU 172).

FIG. 6D illustrates an example scenario 600D, which can occur in the wireless communication system 100, in which MBS content data reception is activated 622 at a UE 102 operating in an idle state 601, the UE 102 and the BS 104 establish a radio connection, thereby causing the UE 102 to transition into a connected state 640, and UE 102 receives 696 MBS content data for the MBS service via a common DL tunnel supported by the established radio connection. At least some of the scenario 600D is generally similar to scenarios 600A, 600B, and/or 600C, and as such, events in scenario 600D similar to those discussed above for scenarios 600A, 600B, and/or 600C are labeled with the same reference numbers, and similar examples and implementations for FIGS. 6A, 6B, and 6C can apply to FIG. 6D. The differences between the scenario 600C and the previously discussed scenarios 600A, 600B, and 600C are discussed below.

As shown in FIG. 6D, in the scenario 600D begins while the UE 102 is operating in the idle state 601. The CN 110 and the DU 174 can perform an MBS resource setup procedure 690, e.g., prior to or in conjunction with the CN 110, BS 104, and UE 102 performing an MBS session activation procedure 692 and the UE activating 622 for receiving content data of the MBS service via the MBS session.

Next, the UE 102, BS 104, and CN 110 perform a state transition procedure 686, which causes the UE 102 to transition from operating in the idle state 601 to operating in a connected state 640 with respect to the DU 174. As shown in FIG. 6D, the state transition procedure 686 can include a random access procedure 636 performed by the UE 102 and the DU 174 of the BS 104, and a radio connection establishment procedure 638 performed by the UE 102 and the CU 172 of the BS 104, thereby causing the UE 102 to transition to operating in the connected state 640. The random access procedure 636 and the radio connection establishment procedure 638 can be any suitable random access procedure and radio connection establishment procedure which are utilized by distributed base stations to connect with UEs. For example, the radio connection establishment procedure 638 can be an RRC establishment procedure. Upon the DU 174 establishing a radio connection with the UE 102, the CU 172 of the BS 104 transmits 642 a CU-to-CN message (e.g., an initial UE message) to notify the CN 110 of the established radio connection with the UE 102, and the CN 110 transmits 644 a response (e.g., an Initial Context Setup Request message) to the CU 172 corresponding to the connection. Based on the received 644 Initial Context Setup Request message, the CU 172 and the UE 102 perform a security mode procedure 646 and a radio connection reconfiguration procedure 648, thereby securing the established radio connection between the UE 102 and the DU 174. Upon securing the radio connection, the CU 172 transmits 650 a response (e.g., an Initial Context Setup Response) to notify the CN 110. Similar to the random access procedure 636 and the radio connection establishment procedure 638, the security mode procedure 646 and the radio connection reconfiguration procedure 648 can be any suitable security mode procedure and radio connection reconfiguration procedure which are utilized by distributed base stations. For example, the radio connection reconfiguration procedure 648 can be an RRC reconfiguration procedure. In another example, the radio connection reconfiguration procedure 648 can be the MBS radio connection reconfiguration procedure 589. In some implementations, the CU 172 can initiate the MBS radio connection reconfiguration procedure 589 in response to the Initial Context Setup Request message.

The events 636, 638, 640, 642, 644, 646, 648, and 650 are collectively referred to in FIG. 6D as the state transition procedure 686.

Further, in embodiments, instead of providing MBS radio resources (i.e., a MRB configuration and a DU configuration like events 518, 520) to the UE 102 in the procedure 648, the BS 104 can perform 688 an MBS radio connection reconfiguration procedure with the UE 102 and CN 110 to provide MBS radio resources to the UE 102, similar to the procedure 587 or 588.

At any rate, after the radio connection between the UE 102 and the BS 104 has been established and secured via the state transition procedure 686, the CN 110 can transmit 696 MBS content data to the UE 102 (now operating in the connected state 640), e.g., via the established common DL tunnel supported by the secured radio connection between the UE 102 and the DU 174. Thus, in the scenario 600D, the UE 102 changes from operating in the idle state 601 to operating in the connected state 640 for receiving 696 MBS content data.

Turning now to FIG. 6E, FIG. 6E illustrates an example scenario 600E, which can occur in the wireless communication system 100, in which reception of content data of an MBS service is activated 622 at a UE 102 operating in an inactive state 603, the UE 102 and the BS 104 resume a radio connection, the UE 102 transitions into operating in the connected state 640, and UE 102 receives 696 MBS content data while operating in the connected state 640 via the resumed radio connection. At least some of the scenario 600E is generally similar to scenarios 600A, 600B, 600C, and/or 600D, and as such, events in scenario 600D similar to those discussed above for scenarios 600A, 600B, 600C, and/or 600D are labeled with the same reference numbers, and similar examples and implementations for FIGS. 6A, 6B, 6C, and 6D can apply to FIG. 6E. The differences between the scenario 600E and the previously discussed scenarios 600A, 600B, 600C, and 600D are discussed below.

As shown in FIG. 6E, the CN 110 and the DU 174 can perform an MBS resource setup procedure 690, e.g., prior to or in conjunction with the CN 110, BS 104, and UE 102 performing an MBS session activation procedure 692, 693, or 694 and the UE activating 622 the for receiving content data for the MBS service via the MBS session.

Next, the UE 102, BS 104, and CN 110 perform a state transition procedure 687. As shown in FIG. 6E, the state transition procedure 687 can include a random access procedure 636 and a radio connection resume procedure 639, after which the UE 102 transitions to operating (again) in the connected state 640 with the BS 104, e.g., via the DU 174. The random access procedure 636 and the radio connection resume procedure 639 can be any suitable random access procedure and radio connection resume procedure which are utilized by distributed base stations. For example, the radio connection resume procedure 639 can be an RRC resume procedure. Subsequent to performing the radio connection resume procedure 639, the UE 102 transitions into operating in the connected state 640.

The events 636, 639, and 640 are collectively referred to in FIG. 6E as the state transition procedure 687.

In cases where the BS 104 has not configured MBS radio resources (i.e., a MRB configuration and a DU configuration like events 518, 520) to the UE 102 in or before the procedure 639, the BS 104 can perform 688 an MBS radio connection reconfiguration procedure with the UE 102 and CN 110 to provide MBS radio resources to the UE 102, similar to the procedure 587 or 588.

Subsequent to performing the state transition procedure 687, the CU 172 can transmit 632 any cached MBS content data (e.g., any content data of the MBS service received by the CU 172 while the UE 102 was operating in the inactive state 603, not shown) to the DU 174, and the DU 174 can transmit or forward 634 the received MBS content data to the UE 102, e.g., via the common DL tunnel of the MBS service supported by the resumed radio connection between the UE 102 and the DU 174. Thus, in the scenario 600E, the UE 102 changes from operating in the inactive state 603 to operating in the connected state 640 for receiving content data of the MBS service, e.g., which may include MBS content data cached at the CU 172 (e.g., associated with events 632, 634), and which may include additional MBS content data sent 696 from the CN 110 to the UE 102 via the common DL tunnel corresponding to the MBS service.

FIG. 6F illustrates an example scenario 600F, which can occur in the wireless communication system 100, in which MBS content data reception is activated 622 at a first UE 102A operating in an inactive state 603 with respect to BS 104, thereby enabling the UE 102B to receive 696 MBS content data via the common DL tunnel established for the MBS service via BS 104. Further, a second UE 102B, which had previously been in the inactive state 603 with respect to the BS 104, has moved physical locations so that the second UE 102B is not associated with the BS 104 but is instead associated with the BS 106, and thus the second UE 102B is in an inactive state 604 with respect to BS 106. Accordingly, the system 100 pages the second UE 102B via BS 106 in order to activate 323 the UE 102B for receiving content data of the MBS service. In FIG. 6F, the BS 104 can be a distributed base station (such as depicted in FIGS. 6A-6E) or can be an integrated base station, and the BS 106 can be a distributed base station or can be an integrated base station. At least some of the scenario 600F is generally similar to scenarios 600A, 600B, 600C, 600D, and/or 600E and, as such, events in scenario 600F similar to those discussed above for scenarios 600A, 600B, 600C, 600 D, and/or 600E are labeled with the same reference numbers, and similar examples and implementations for FIGS. 6A, 6B, 6C, 6D, and 6E can apply to FIG. 6F. The differences between the scenario 600E and the previously discussed scenarios 600A, 600B, 600C, 600D, and 600E are discussed below.

In the scenario 600F, the CN 110 and the DU 174 can perform an MBS resource setup procedure 690 (e.g., prior to or in conjunction with the CN 110, BS 104, and UE 102A performing an MBS session activation procedure 692, 693, or 694) to setup resources at the BS 104 for supporting the common DL tunnel for the MBS service. The UE 102A activates 622 for receiving content data of the MBS service, and the UE 102A and the BS 104 perform a radio connection resume procedure 639 to thereby resume the radio connection between the UE 102A and BS 104 to support the common DL tunnel for the MBS service. Via the common DL tunnel of the MBS service supported by the resumed radio connection, the BS 104 can send 617 any content data of the MBS service which the BS 104 had received and cached while the radio connection between the UE 102A and the BS 104 was suspended. Further, the CN 110 can transmit 696 further MBS content data to the UE 102A via the common DL tunnel. In the scenario 600F, the UE 102A continues operating in the inactive state 603 while the UE 102A receives 617, 696 content data of the MBS service; however, in some embodiments (not shown), the UE 102A can transition to operating in a connected state 640 with respect to the BS 104 to receive 617, 696 content data of the MBS service.

Similar to the UE 102A, the UE 102B has also previously indicated interest in the MBS service. However, as described above, the UE 102B is operating in an inactive state 605 with respect to the BS 106 instead of with respect to the BS 104. As such, the BS 104 sends 652, to the BS 106, a BS-to-BS message instructing the BS 106 to page the UEs indicated within the BS-to-BS message for the MBS service. For example, the BS 104 can transmit 652 a single, multicast paging message to the BS 106, where the multicast paging message includes the MBS session ID, an indication of respective identifications of one or more UEs which are to be paged for the MBS service (which, in scenario 600F, includes UE 102B), and indication of respective UE radio capabilities of the indicated UEs. The format of the contents of the multicast paging message can be similar to that of the multicast paging messages discussed elsewhere within this document for other events, such as the multicast paging messages associated with the events 614 and 616. For example, the multicast paging message may indicate multiple UEs, or the multicast paging message may indicate a single UE. In the scenario 600F in particular, the BS 104 can easily populate the BS-to-BS multicast paging message with the indication of the respective radio capabilities for the indicated UEs, as the indicated UEs have previously been in an inactive state 603 with respect to the BS 104 immediately prior to moving into the coverage area of BS 106 and, as such, the BS 104 is storing the indication of the UEs' respective radio capabilities. In some implementations, the BS-to-BS message at event 652 is the RAN Multicast Group Paging message defined for 3GPP TS 38.423 XnAP.

At the BS 106, upon receiving 652 the single, multicast paging message from BS 104, BS 106 determines 618 respective paging schemes for the UEs indicated therein, and the BS 106 pages 620 each indicated UE (including paging 620 UE 102B) in accordance with the UE's respective radio capabilities, e.g., as indicated in the received 652 multicast paging message. Each paging message includes the MBS session ID so that the recipient UE can activate 623 MBS content data reception for the MBS service via the BS 106.

The events 652, 618, and 620 are collectively referred to in FIG. 6F as a BS-initiated MBS session activation procedure 695.

In other embodiments of the BS-initiated MBS session activation procedure (not shown), instead of the BS 104 sending 652 a multicast paging message indicating multiple UEs that are to be paged for the MBS service, the BS 104 can send, to the BS 106, a respective unicast paging message for each UE that is to be paged for the MBS service (e.g., multiple unicast paging messages), where each unicast paging message indicates only one respective UE, the radio capabilities of the only one respective UE, and the MBS session ID. Upon the BS 106 receiving each per-UE unicast paging message, the BS 106 can page 620 the indicated UE for the MBS service.

At any rate, continuing with the scenario 600F, upon activating 623 the UE 102B for receiving MBS content data for the MBS service, the UE 102B, BS 104, and BS 106 perform a state transition procedure 685 to resume the radio connection of the UE 102B with the system 100, albeit with the BS 106 instead of with the BS 104. For example, as shown in in FIG. 6F, the UE 102B and the BS 106 perform a random access procedure 635, and the UE 102B and the BS 104 perform a radio connection resume procedure with UE context retrieval 637 to thereby cause the UE 102B to transition from operating in the inactive state with respect to BS 106 to operating in a connected state 643 with respect to BS 106 via the resumed radio connection. Lastly, the CN 110 and the BS 106 perform a path switch procedure 641 so that the path between the CN 110 and the UE 102B is via the BS 106 instead of via the BS 104. The random access procedure 635 and the radio connection resume procedure with UE context retrieval 637 can be any suitable random access procedure and radio connection resume procedure with UE context retrieval utilized when UEs operating in an inactive state with respect to one base station move to the coverage area of another base station. For example, the radio connection resume procedure with UE context retrieval 637 can be an RRC resume procedure with UE context retrieval.

The events 635, 637, 643, and 639 are collective referred to within FIG. 6F as the state transition procedure (including UE context retrieval and path switch) 685.

In some situations, a common DL tunnel for the MBS service already exists between the CN 110 and the BS 106, for example, because the CN 110 and the BS 106 have already performed an MBS resource setup procedure 691 at some time prior to the UE 102B entering into the connected state 643 with respect to the BS 106. For instance, another UE (not shown in FIG. 6F) which is interested in the MBS service can be located within the coverage area of the BS 106, and the CN 110 and BS 106 have performed the MBS resource setup procedure 691 to deliver content data of the MBS service to the another interested UE via the BS 106. In these situations, the CN 110 can transmit 625 MBS content data for the MBS service to the BS 106 via the existing common DL tunnel, and the BS 106 can transmit or forward 629 the received MBS content data to the UE 102B.

In other situations, a common DL tunnel for the MBS service does not already exist between the CN 110 and the BS 106, e.g., because no other UEs currently serviced by the BS 106 are interested in the MBS service. In these situations, the scenario 600F can include establishing a common DL tunnel between the CN 110 and the BS 106, e.g., by performing a MBS resource setup procedure 691 for the BS 106 after performing the path switch procedure 641 (e.g., instead of performing the MBS resource setup procedure 691 as illustrated in the scenario 600F).

Turning now to FIG. 7A, FIG. 7A illustrates an example scenario 700A, which can occur in the wireless communication system 100, in which the CN 110 transmits 712, to the CU 172 of the BS 104, a single, multicast paging message indicating multiple UEs for paging for an MBS service, and the CU 172 instructs the DU 174 to page UE 102A and UE 102B via respective unicast paging messages. Generally, the scenario 700A is similar to the scenario 600A of FIG. 6A; however, in the scenario 700A, the CU 172 instructs the DU 174 to page interested UEs by transmitting multiple respective unicast paging messages 715, 765 on a per-UE basis rather than transmitting 616 a single multicast paging message indicating multiple interested UEs as in the scenario 600A. Further, as is discussed below, at least other portions of the scenario 700A are generally similar to aspects of scenarios 600A, 600B, 600C, 600D, 600E, and/or 600F and thus similar examples and implementations for FIGS. 6A, 6B, 6C, 6D, 6E, and 6F can apply to FIG. 7A. The differences between the scenario 700A and the previously discussed scenarios 600A, 600B, 600C, 600D, 600E, and 600F are discussed below.

As shown in the scenario 700A, both the UE 102A and the UE 102B are located in the coverage area of the base station 104, both UEs 102A, 102B are associated with the DU 174 of the distributed BS 104, and each of the UEs 102A, 102B is operating in an idle state or an inactive state with respect to the DU 174, respectively denoted by references 702A and 702B. In FIG. 7A, the CN 110 and the BS 104 can perform an MBS resource setup procedure 790 at some time prior to or in conjunction with the CN 110 instructing 712 the BS 104 to page interested UEs for the MBS service, where the MBS resource setup procedure 790 can be generally similar to the MBS resource setup procedure 690 of FIG. 6A. Additionally, and generally similar to the event 614 of FIG. 6A, in FIG. 7A the CN 110 can send 712 a CN-to-BS message instructing the CU 172 of the BS 104 to page multiple UEs for the MBS service, where CN-to-BS message is a multicast paging message indicating the MBS session ID, at least the UEs 102A, 102B, and optionally the respective radio configurations of the indicated UEs. However, instead of the CU 172 sending 616 a second corresponding multicast paging message to one or more DUs 174 as in FIG. 6A, in FIG. 7A the CU 172 sends 715, 765 a different, per-UE unicast paging message to the DU 174 for each interested UE indicated in the multicast paging message received 712 by the CU 172. That is, the CU 172 sends 715 a first CU-to-DU unicast paging message indicating the MBS session ID, an indication of only the UE 102A, and optionally respective radio capability information of the UE 102A. Similarly, the CU 172 sends 765 a second CU-to-DU unicast message indicating the MBS session ID, an indication of only the UE 102B, and optionally respective radio capability information of the UE 102B. The CU 172, though, can generate and populate the content of each different unicast paging message of events 715, 765 in a manner similar to generating and populating the contents of the single, multicast paging message of event 616, e.g., based on whether each interested UE is in an inactive or in an idle state, based on whether the CU 172 or the DU 172 stores any UE radio capability information, based on whether the CN 110 has sent UE radio capability information for any UEs to the CU 172, and/or in other manners such as previously described.

At the DU 174, and based on the respective receptions of the unicast paging messages sent 715, 758 by the CU 172, the DU 174 determines 718 a respective paging scheme for the UE 102A and performs a respective MBS session paging procedure 720 for the UE 102A using the respective radio capabilities of the UE 102A, and the DU 174 determines 758 a respective paging scheme for the UE 102B and performs a respective MBS session paging procedure 760 for the UE 102B using the respective radio capabilities of the UE 102B. Generally speaking, the determining 718, 758 of the paging schemes in FIG. 7A can be similar to the determining 618 of the paging scheme of one of the multiple UEs shown FIG. 6A, and the paging procedures 720, 760 of FIG. 7A can be similar to a single paging procedure of the group of paging procedures 620 shown in FIG. 6A.

In response to the respective paging procedures 720, 760, the UE 102A and the UE 102B respectively activate 722, 721 content data reception for the MBS service thereby establishing or joining (as the case may be) the common DL tunnel for the MBS service. In some cases, when the UE 102A and/or the UE 102B are operating in an inactive state 702A, 702B, the UE 102A and/or the UE 102B can remain operating in the inactive state 702A, 702B and receive 796 further MBS content data transmitted by the CN 110 via the established common DL tunnel for the MBS service while operating in the inactive state 702A, 702B. In other cases when the UE 102A and/or the UE 102B is in an inactive state 702A, 702B, the UE 102A and/or the UE 102B can perform a respective state transition procedure 786, 787 to transition into operating in the connected state prior to receiving 796 the further MBS content data from the CN 110. Further, when the UE 102A and/or the UE 102B is in an idle state 702A, 702B, the UE 102A and/or the UE 102B can perform a respective state transition procedure 786, 787 to transition into operating in the connected state prior to receiving 796 the further MBS content data from the CN 110. Generally speaking, the state transition procedure 786 can be similar to the state transition procedure 686 of FIG. 6D, and the state transition procedure 787 can be similar to the state transition procedure 687 of FIG. 6E.

FIG. 7B illustrates an example scenario 700B, which can occur in the wireless communication system 100, in which the CN 110 transmits 712, to the CU 172 of the BS 104, a first, single multicast paging message indicating multiple UEs to page for an MBS service, and subsequently the CU 172 instructs 714 the DU 174 to page the multiple UEs via a corresponding, second single multicast paging message. Generally, the scenario 700B is similar to the scenario 600A of FIG. 6A and/or the scenario 700A of FIG. 7A. Further, as is discussed below, at least other portions of the scenario 700A are generally similar to aspects of scenarios 600A, 600B, 600C, 600D, 600E, 600F, and/or 700A and thus similar examples and implementations for FIGS. 6A, 6B, 6C, 6D, 6E, 6F, and 7A can apply to FIG. 7B. The differences between the scenario 700B and the previously discussed scenarios 600A, 600B, 600C, 600D, 600E, 600F, and 700A are discussed below.

As shown in the scenario 700B, and similar to the scenario 700A, both the UE 102A and the UE 102B are located in the coverage area of the base station 104, both UEs 102A, 102B are associated with the DU 174 of the distributed BS 104, and each of the UEs 102A, 102B is operating in an idle state or an inactive state with respect to the DU 174, respectively denoted by references 702A and 702B. Also similar to the scenario 700A, in scenario 700B the CN 110 and the BS 104 can perform an MBS resource setup procedure 790 at some time prior to or in conjunction with the CN 110 instructing 712 the BS 104 to page interested UEs for the MBS service, where CN-to-BS message is a single, multicast paging message indicating the MBS session ID, an indication of multiple UEs interested in the MBS service (including the UEs 102A, 102B), and optionally the respective radio configurations of the indicated UEs.

However, different than the scenario 700A of FIG. 7A, and similar to the scenario 600A of FIG. 6A, in the scenario 700B, upon the CU 172 receiving 712 the single, (first) multicast paging message from the CN 110, the CU 172 generates and transmits 714 a corresponding, single second multicast paging message to the DU 174, where the second multicast paging message indicates the MBS session ID, an indication of multiple interested UEs (including the UEs 102A and 102B) which are in the idle state or inactive state with respect to the DU 174, and optionally respective radio capability information of the indicated UEs. The CU 172 can populate the contents of the single, second multicast paging message in a manner similar to the event 616 of FIG. 6A, for example.

The DU 174, upon receiving 714 the single, second multicast paging message, can determine 718, 758 the respective paging scheme of each UE 102A, 102B indicated within the second, multicast paging message, and the DU 274 can initiate a respective MBS session paging procedure 720, 760 for each indicated UE 102A, 102B using the respective determined paging scheme, e.g., in a manner similar to that discussed for events 718, 720, 758, and 760 in FIG. 7A. Further, the events 721, 722, 786, 787, and 796 can also be implemented in a manner similar to that discussed for the same events in FIG. 7A, for example.

FIG. 7C illustrates an example scenario 700C, which can occur in the wireless communication system 100, in which the CN 110 transmits 712, to a first BS 106, a first, single multicast paging message indicating multiple UEs to page for an MBS service. Upon receiving 712 the first, single multicast paging message, the first BS 106 transmits 713, 763 to a second BS 104 into whose coverage area at least some of the multiple UEs have moved, multiple unicast paging messages, each of which indicates a different UE to page for the MBS service. As discussed below, at least portions of the scenario 700C are similar to aspects of scenarios 600A, 600B, 600C, 600D, 600E, 600F, 700A, and/or 700B and thus similar examples and implementations for FIGS. 6A, 6B, 6C, 6D, 6E, 6F, 7A, and 7B can apply to FIG. 7C. The differences between the scenario 700C and the previously discussed scenarios 600A, 600B, 600C, 600D, 600E, 600F, 700A, and 700B are discussed below.

As shown in the scenario 700C, both the UE 102A and the UE 102B have moved from being located in the coverage area of the BS 106 to being located in the coverage area of BS 104, and each of the UEs 102A, 102B is operating in an idle state or an inactive state with respect to BS 104 (e.g., as respectively denoted in FIG. 7C by references 702A and 702B). In scenario 700C, the CN 110 and the BS 106 can perform an MBS resource setup procedure 790 at some time prior to or in conjunction with the CN 110 instructing 712 the BS 106 to page interested UEs for the MBS service, e.g., by transmitting 712 a single, multicast paging message including an indication of multiple UEs (including UE 102A and UE 102B) which are to be paged for the MBS service. At the BS 106, upon receiving 712 the multicast paging message, and because BS 104 (and not BS 106) needs to page (at least) UEs 102A, 102B, BS 106 transmits 713, 763 to the BS 104, multiple BS-to-BS messages, where each BS-to-BS message is a single, unicast paging message indicating a different (and only one) UE to be paged for the MBS service by BS 104. That is, contrasting with scenario 600F, in scenario 600F the BS 104 transmits 652, to BS 106, a single, multicast paging message to indicate the multiple UEs to be paged, whereas in scenario 700C BS 106 transmits 713, 763 multiple per-UE unicast paging messages to the BS 104 to indicate the multiple UEs to be paged. Similar to the scenario 600F, though, the BS 104 can easily populate each unicast paging message with the indication of the respective radio capabilities for the indicated UE as the indicated UE had previously been in an inactive state with respect to the BS 104 immediately prior to moving into the coverage area of BS 106 and consequently the BS 104 is storing the indication of the respective radio capabilities of the indicated UE.

In scenario 700C, upon BS 104 receiving 718, 768 each unicast paging message, the BS 104 determines 718, 758 a respective paging scheme for the UE indicated by the received unicast paging message, and the BS 104 performs a respective MBS session paging procedure 720, 760 for the indicated UE, thereby respectively activating 722, 721 each indicated UE (e.g., UE 102A and UE 102B) for receiving content data of the MBS service. Subsequently, as shown in FIG. 7C, the UE 102A and the CN 110 can perform 784 a state transition procedure (including context retrieval of the UE 102A and path switch from BS 106 to BS 104), thereby causing the UE 102A to operate in the connected state with respect to BS 104 and enabling the UE 102A to join the MBS session of the MBS service via BS 104. Similarly, the UE 102B and the CN 110 can perform 785 a state transition procedure (including context retrieval of the UE 102B and path switch from BS 106 to BS 104), thereby causing the UE 102B to operate in the connected state with respect to BS 104 and enabling the UE 102B to join the MBS session of the MBS service via BS 104. Generally, the state transition procedures 784, 785 including UE context retrieval and path switch can be similar to the state transition procedure 685 including UE context retrieval and path switch.

In the scenario 700C, when the BS 104 already supports an existing common DL tunnel for the MBS service (e.g., due to the BS 104 having previously set up MBS resources for another UE interested in the MBS service, not shown), the CN 110 can transmit 796 content data of the MBS service to the UE 102A and the UE 102B via the existing, common DL tunnel. Otherwise, the BS 104 and the CN 110 can perform 790 an MBS resource setup procedure to establish the common DL tunnel via the BS 104, thereby enabling the CN 110 to transmit 796 MBS content data to the UE 102A and to the UE 102B via the established common DL tunnel for the MBS service. Further, although FIG. 7C denotes the MBS resource setup procedure 790 occurring after the state transition procedure 784, the MBS resource setup procedure 790 can occur at any time after an activation of MBS service content data for at least one UE (e.g., event 721 for UE 102B, event 722 for UE 102A), prior to the CN 110 transmitting 796 MBS service content data to the at least one UE 102A, 102B.

FIG. 7D illustrates an example scenario 700D, which is generally similar to example scenario 700C of FIG. 7C. In FIG. 7D, though, upon the BS 106 receiving 712, from the CN 110, the single, multicast paging message indicating multiple UEs (including UE 102A and UE 102B) for the MBS service, instead of the BS 106 transmitting 713, 763, to BS 104, a different unicast paging message for each indicated UE as in FIG. 7C, in FIG. 7D the BS 106 transmits 711 a corresponding single, multicast paging message indicating the multiple UEs (including UE 102A and UE 102B) to BS 104. The single, multicast paging message transmitted 711 by BS 106 to BS 104 can include information similar to that as discussed above for other scenarios, such as the MBS session ID, an indication of the multiple UEs, and the indication of the respective radio capabilities of the indicated UEs.

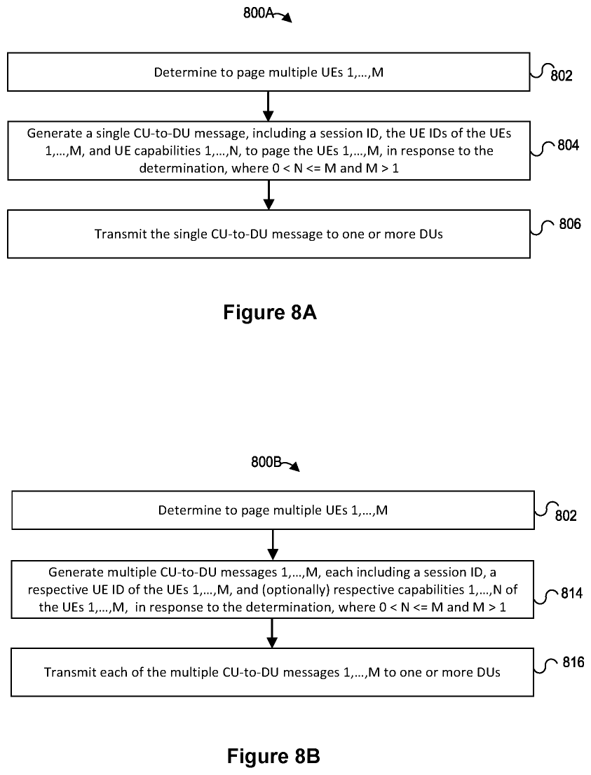

Next, several example scenarios which devices illustrated in FIGS. 1A-7D can implement are discussed with reference to FIGS. 8A-15. Each of these methods can be implemented as a set of instructions stored on a non-transitory computer-readable medium and executable by one or more processors, for example.

Referring first to FIG. 8A, a CU can implement a method 800A to instruct a DU to page one or more UEs for an MBS service. For example, the CU can be the CU 172 of the base station 104, and the DU can be the DU 174 of the base station 104. The method 800A begins at block 802, where the CU determines to page 1-M UEs for an MBS service, where M is an integer greater than one (see, e.g., events 614, 630, and 712, whose respective occurrences can trigger the CU to determine 802 to page 1-M UEs for the MBS service). At block 804, in response to the determination 802, the CU generates a single CU-to-DU message that indicates the set of UEs 1-M. In some implementations, the CU-to-DU message can be an interface message. For example, the interface message can be an F1 interface message such as a F1 application protocol (F1AP) message. In other implementations, the CU-to-DU message can be a multicast paging interface message (e.g., a F1AP multicast paging message).

The generated CU-to-DU message can include a session ID of the MBS session of the MBS service, an indication of the respective identification of each of the 1-M UEs, and a total number of N indications of the respective sets of radio capabilities (e.g., capability IEs, fields of capability IEs, or other suitable indications) of the 1-M UEs, for example. In some implementations, the UE ID is a 5G-S-TMSI. Further, the total number N of indicated sets of radio capabilities (where N is an integer equal to or greater than one) can be less or equal to the total number M of indicated UEs. In some implementations, for example, when multiple UEs share common radio capabilities, N is less than M. In other implementations, for example, not all M UEs provide the respective sets of radio capabilities (e.g., radio capability for paging) as they may not support such function and only a total number N respective sets of radio capabilities for paging (out of the M UEs) is available at the CU. In some implementations, the indication of a set of UE radio capabilities can be a capability IE, such as described above. In other implementations, the indication of each set of UE radio capabilities can be a field or IE included in the UE radio capability IE, e.g., such as described above. In other implementations, the indication of a set of UE radio capabilities can be a UE-NR-Capability IE or a UE-6G-Capability IE, each of which can include plural UE capabilities for communication with a 5G RAN or a 6G RAN.

At block 806 of the method 800A, the CU transmits the generated CU-to-DU message to one or more DUs, thereby instructing the one or more DUs to page the indicated UEs 1-M.

Referring now to FIG. 8B, a CU can implement a method 800B to instruct a DU to page one or more UEs for an MBS service. For example, the CU can be the CU 172 of the base station 104, and the DU can be the DU 174 of the base station 104. The method 800B begins at block 802, where the CU determines to page 1-M UEs for an MBS service, in a manner similar to that of event 802 of the method 800A. At block 814, in response to the determination 802, though, the CU generates a respective CU-to-DU message for each of the UEs 1-M to indicate, to the DU, that the DU is to page each of the UEs 1-M. That is, at the block 814, the CU generates a total of M CU-to-DU messages, each corresponding to a different UE 1-M.

In some implementations, each CU-to-DU message generated 814 by the CU can include a session ID of the MBS session of the MBS service, an indication of one of the 1-M UEs, and an indication of a respective set of radio capabilities of the indicated UE. Further, a total number N of indicated sets of radio capabilities (where N is an integer greater than or equal to one) can be less or equal to the total number M of UEs. For example, when multiple UEs share common radio capabilities, N is less than M. In cases in which N equals M, a first CU-to-DU message corresponding to UE 1 can include the MBS session ID, an indication of the identification of UE 1, and a capability IE 1; a second CU-to-DU message corresponding to UE 2 can include the MBS session ID, an indication of the identification of UE 2, and a capability IE 2; . . . , and so on through the Mth CU-to-DU message corresponding to UE M including the MBS session ID, an identification of the UE M, and a capability IE M. In cases in which N is less than M (that is, in which at least two of the UEs 1-M share the same UE radio capabilities), a first CU-to-DU message corresponding to UE 1 can include the MBS session ID, an indication of the identification of UE 1, and a capability IE 1; a second CU-to-DU message corresponding to UE 2 can include the MBS session ID, an indication of the identification of UE 2, and a capability IE 2; . . . , and the Nth CU-to-DU message corresponding to UE N can include the MBS session ID, an identification of the UE N, and a capability IE N. Each of the remaining CU-to-DU messages (e.g., the CU-to-DU messages corresponding to UE (N+1) through UE M can include the MBS session ID and the identification of the corresponding remaining UE while omitting any indication of UE radio capabilities. For example, the N+1^{st} CU-to-DU message corresponding to UE (N+1) can include the MBS session ID and the identification UE (N+1), the N+2^{nd} CU-to-DU message corresponding to UE (N+2) can include the MBS session ID and the identification UE (N+2), and so on.

In other implementations, each CU-to-DU message generated 814 by the CU can include a session ID of the MBS session of the MBS service, an indication of each of the 1-M UEs, and optionally an indication of a respective set of radio capabilities of the indicated UE. For example, not all M UEs provide the indication of a respective set of radio capabilities (e.g., radio capability for paging) as they may not support such function and only a total number N respective set of radio capabilities (out of the M UEs) is available at the CU. The N indications of a respective set of radio capabilities may not necessarily be different from each other.

In yet another implementations, each CU-to-DU message generated 814 by the CU can include a session ID of the MBS session of the MBS service, an indication of each of the 1-M UEs, and an indication of a respective set of radio capabilities of the indicated UE. The indication of a respective set of radio capabilities may be a predetermined (default) capability for UEs interested in receiving MBS and specifically corresponding to a certain UE.

At block 816 of the method 800B, the CU transmits the generated CU-to-DU messages to one or more DUs, thereby instructing the one or more DUs to page the indicated UEs 1-M.

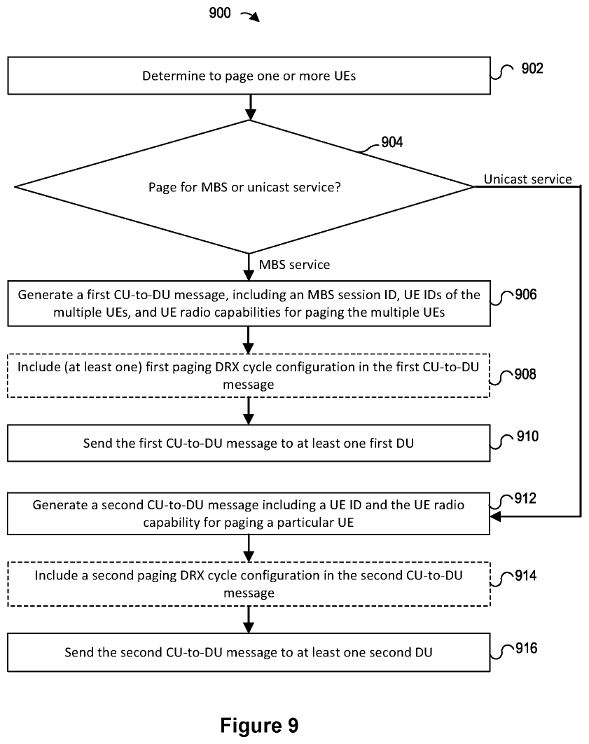

Turning now to FIG. 9, a CU can implement a method 900 to instruct one or DUs to page one or more UEs for an MBS service. For example, the CU can be the CU 172 of the base station 104, and the DU can be the DU 174 of the base station 104. The method 900 begins at block 902, where the CU determines to page one or more UEs for a service. At block 904, the CU determines whether the service is an MBS service or a unicast service. When the CU determines 904 that the service is an MBS service, the method 900 proceeds to block 906, at which the CU generates a first CU-to-DU message that includes the MBS session ID for the MBS service, an indication of the respective identifications of the one or more UEs, and an indication of respective sets of UE radio capabilities of the one or more UEs, which can be represented, for example, by a respective capability IE of each indicated UE. Additionally, at block 908, the CU can optionally include, in the first CU-to-DU message, an indication of a respective discontinuous reception (DRX) cycle configuration for at least one UE of the one or more UEs. At a block 910, the CU can send or transmit the first CU-to-DU message to one or more DUs (see e.g., event 616 and event 714).

On the other hand, when, at the block 904, the CU determines that the service is a unicast service, the method 900 proceeds to block 912, at which the CU generates a second set of CU-to-DU messages, each of which corresponds to a different UE of the one or more UEs. For example, each CU-to-DU message included in the second set of CU-to-DU messages can include an indication of an identification of a respective UE, a session ID uniquely corresponding to the combination of the unicast service and the respective UE, and an indication of the UE radio capabilities of the respective UE. Additionally, at a block 914, the CU can optionally include, in each CU-to-DU message, an indication of a respective DRX cycle configuration of the respective UE. At a block 916, the CU can send or transmit the second set of CU-to-DU messages to one or more DUs (see e.g., events 715 and 765; events 713 and 763), which may be the same or a different set of one or more DUs to which the CU sent or transmitted the first CU-to-DU message.

Via the method 900, a particular UE can be indicated for paging for the multicast service only, for the unicast service only, or for both the multicast service and the unicast service. Further, in some implementations the first CU-to-DU message and the second set of CU-to-DU messages can be interface messages. For example, the interface messages can be F1 interface messages such as F1 application protocol (F1AP) messages. In other implementations, the first CU-to-DU message can be a multicast paging interface message (e.g., a F1AP multicast paging message), and each CU-to-DU message included in the second set of CU-to-DU messages can be a paging interface message (e.g., a F1AP paging message).

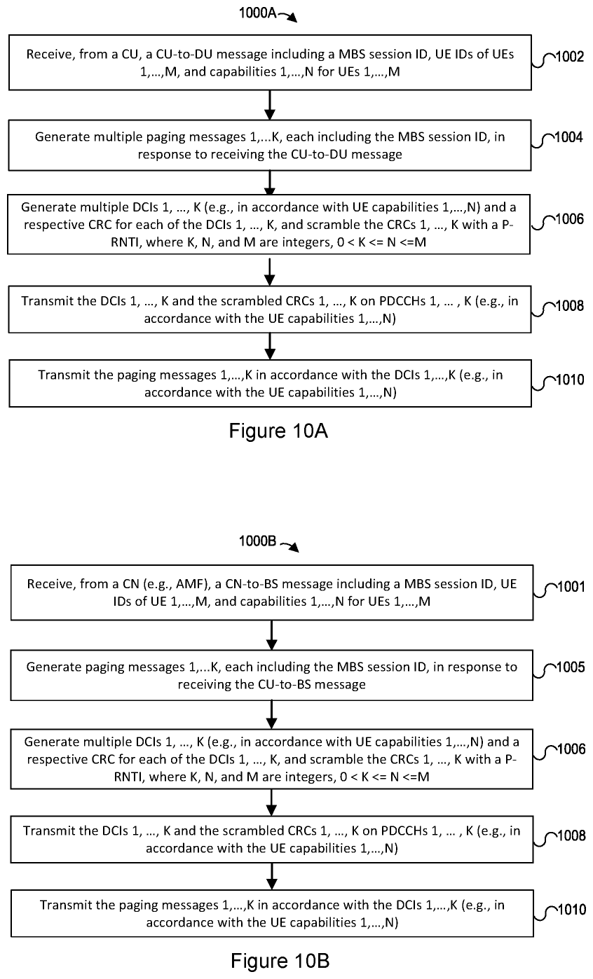

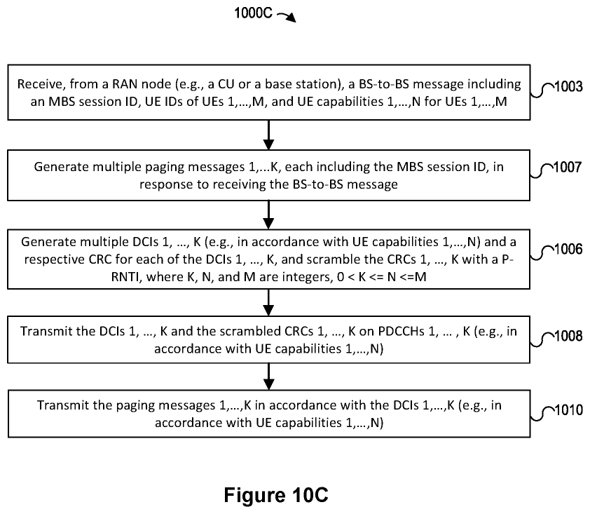

Turning now to FIG. 10A, a DU can implement a method 1000A to page one or more UEs for an MBS service. For example, the DU can be the DU 174 of the base station 104. The method 1000A begins at block 1002, where the DU receives, from a CU (such as the CU 172 of base station 104), a CU-to-DU message including a session ID of an MBS session of the MBS service and an indication of respective identifications of UEs 1-M that the DU and N indications of a respective set of UE radio capabilities in the M UEs is to page for an MBS service, where M and N are integers greater than one and N is smaller than or equal to M. In some implementations, the received CU-to-DU message also includes an indication of a respective set of UE radio capabilities for each UE 1-M, where the respective sets of UE radio capabilities may be represented, for example, by respective capability IEs. For example, the received CU-to-DU message can include a respective capability IE for each UE 1-M. A total number N of different sets of UE radio capabilities can be indicated, where N is an integer greater than or equal to one, and N is less than or equal to the total number of UEs M. For example, when different UEs utilize a common set of UE radio capabilities, N is less than M.

In other implementations, the received CU-to-DU message optionally includes an indication of a respective set of UE radio capabilities for each UE 1-M. For example, not all M UEs provide the indication of a respective set of radio capabilities (e.g., radio capability for paging) as they may not support such function and only a total number N indication of a respective set of radio capabilities (out of M UEs) is available at the CU. The N indications of a respective set of radio capabilities may not necessarily be different from each other.

In response to receiving 1002 the CU-to-DU message, at block 1004 the DU can generate a set of paging messages to utilize in paging the UEs 1-M, where each paging message includes the session ID of the MBS session of the MBS service, and each paging message corresponds to a respective set of resource allocation information (e.g., a respective combination of time domain resource allocation, frequency domain resource allocation, and modulation scheme). Indeed, at block 1006, the DU can generate the different sets of resource allocation information corresponding to the paging messages for the UEs 1-M, and specifically, corresponding to the different sets of UE radio capabilities of the UEs 1-M. For example, the DU can generate a total number K of different sets of resource allocation information, where K is an integer greater than or equal to one, and K is an integer less than or equal to the total number N sets of UE radio capabilities for the M UEs. For example, when different sets of UE radio capabilities utilize a common set of resource allocation information, K is less than N. That is, mathematically speaking, 0<K<=N<=M. As such, at the block 1004, the DU can generate K different paging messages, and at the block 1006 the DU can generate K different sets of resource allocation information.

In an embodiment, each different set of resource allocation information (e.g., each different combination of allocated respective time domain resources, allocated respective frequency domain resources, and modulation scheme) can be represented by different Downlink Control Information or DCIs. Further, in some implementations, at the block 1006 the DU can generate a respective cyclical redundancy code (CRC) for each DCI, and can scramble each CRC with a Paging Radio Network Temporary Identifier (P-RNTI) or other suitable paging identifier, e.g., as illustrated in FIG. 10A.

At a block 1008, the DU can transmit each set of the K different sets of resource allocation information on one or more shared downlink control channels, such as on a Physical Downlink Control Channel (PDCCH) and/or other suitable shared downlink control channels. In implementations in which the different sets of resource allocations are different DCIs and the CU generates respective scrambled CRCs for each DCI, the DU can transmit the respective scrambled CRC in conjunction with transmitting each DCI on the one or more shared downlink control channels.

Further, at a block 1010, the DU can transmit, e.g., via one or more suitable shared downlink data channels (such as a Physical Downlink Shared Channel (PDSCH) and/or other suitable shared downlink data channels), each generated paging message in accordance with a respective set of UE radio capabilities of the UEs 1-M, thereby paging each of the UEs 1-M.

Referring now to FIG. 10B, a base station can implement a method 1000B to page one or more UEs for an MBS service. The base station implementing the method 1000B can be an integrated base station or can be a distributed base station. For example, the base station can be the base station 104 or the base station 106. The method 1000B is generally similar to the method 1000A; however, instead of a DU receiving 1002 a CU-to-DU message indicating the UEs 1-M and instructing the DU to page the indicated UEs 1-M, e.g., as shown in method 1000A, in method 1000B a BS receives 1001 a CN-to-BS message (e.g., from a Core Access and Mobility Management Function (AMF) or similar) indicating the UEs 1-M and instructing the BS to page the indicated UEs 1-M. The received CN-to-BS message can include a session ID of an MBS session of the MBS service and an indication of respective identifications of UEs 1-M that the BS is to page for an MBS service. In some implementations, the received CN-to-BS message also optionally includes an indication of a respective set of UE radio capabilities for each UE 1-M, where the respective sets of UE radio capabilities may be represented, for example, by respective capability IEs. For example, not all M UEs provide the indication of a respective set of radio capabilities (e.g., radio capability for paging) as they may not support such function and only a total number N respective set of radio capabilities (out of the M UEs) is available at the BS. The N indications of a respective set of radio capabilities may not necessarily be different from each other.

In response to receiving 1001 the CN-to-BS message, the BS can generate 1005 a set of paging messages, e.g., a set of K different paging messages, each of which includes the ID of the MBS session of the MBS service. Subsequently, the remainder of method 1000B (e.g., steps 1006, 1008, and 1010) can be implemented by the BS in manner similar to that implemented by the DU in FIG. 10A.

In some implementations of the method 1000A of FIG. 10A and/or the method 1000B of FIG. 10B, a particular capability IE X (e.g., at the block 1002 and/or the block 1001) includes information of supported NR bands and/or information of supported downlink scheduling offset(s) as described for FIG. 6A, where 1<=X<=N. In some implementations, the RAN node (e.g., a DU or base station) can determine to transmit a particular set of resource allocation information (e.g., a particular DCI) on at least one carrier frequency in the supported NR bands. In some implementations, the RAN node can indicate a downlink scheduling slot offset (e.g., the offset is greater than 0) in the particular set of resource allocation information in situations in which the information of supported downlink scheduling offset(s) indicate support of the downlink scheduling slot offset for the at least one carrier frequency. In cases where the particular capability IE X does not include information of supported NR bands, the RAN node can determine to transmit the particular set of resource allocation information to predetermined carrier frequency(ies). In cases where the capability IE X does not include information of supported downlink scheduling offset(s), the RAN node can indicate a downlink scheduling slot offset (e.g., the offset is equal to 0) or refrain from include a downlink scheduling slot offset in the particular set of resource allocation information.

In some implementations of the method 1000A and/or the method 1000B, the capability IE X (e.g., at the block 1002 and/or the block 1001) can include an indication of a wake-up signal being supported at the corresponding UE Y, where 1<=Y<=M. As such, when the capability IE X includes an indication that wake-up signals are supported at the UE Y, the RAN node (e.g., a CU or a BS) can send a wake-up signal on a paging occasion before transmitting the particular set of resource allocation information on the paging occasion. Further, if the UE Y detects the wake-up signal, the UE Y attempts to receive a corresponding set of resource allocation information (e.g., a corresponding DCI) via a shared downlink control channel Y (e.g., PDCCH Y) on the paging occasion. Otherwise, the UE Y may not attempt to receive (e.g., can refrain from receiving) a corresponding set of resource allocation information on the shared downlink control channel Y on the paging occasion. Additionally, when the capability IE X does not include an indication of wake-up signal support, the RAN node can refrain from sending a wake-up signal ahead of sending the set of resource allocation information corresponding to UE Y on a paging occasion.

In some implementations of the method 1000A and/or the method 1000B, the capability IE X (e.g., at the block 1002 and/or the block 1001) can include an indication of support for a paging early indication (PEI) at a corresponding UE Y, where 1<=Y<=N. In cases in which the capability IE X includes an indication of support for PEI at the particular UE Y, the RAN node (e.g., a CU or a BS) can include an PEI field in the corresponding set of resource allocation information (e.g., the corresponding DCI). If the UE Y receives the corresponding set of resource allocation information on a paging occasion and identifies the included PEI, the UE Y can attempt to receive, via a shared downlink data channel (such as a PDSCH) in accordance with the corresponding set of resource allocation information, a transmission including the paging message. Otherwise, the UE Y may not attempt to receive (or may refrain from receiving), via the shared downlink data channel, any transmission in accordance with the corresponding set of resource allocation information. In some implementations, the UE Y receives a transmission via the shared downlink data channel in accordance with the corresponding set of resource allocation information irrespective of indicated support (or lack thereof) for PEI. If the UE Y receives the corresponding set of resource allocation information on a paging occasion and identifies the PEI, the UE Y in such cases can attempt to decode, in accordance with the corresponding set of resource allocation information, a transmission received via the shared downlink data channel and including the paging message. Otherwise, the UE Y may not attempt to decode, in accordance with the corresponding set of resource allocation information, any transmission that is received via the shared downlink data channel.

Referring now to FIG. 10C, a base station can implement a method 1000C to page one or more UEs for an MBS service. The base station implementing the method 1000C can be an integrated base station or can be a distributed base station, for example. For example, the base station can be the base station 104. The method 1000C is generally similar to the method 1000A; however, instead of a DU receiving 1002 a CU-to-DU message indicating the UEs 1-M and instructing the DU to page the indicated UEs 1-M as shown in method 1000A, in method 1000C a base station receives 1003, from a RAN node (such as from a CU of a distributed base station or from an integrated base station), a BS-to-BS message indicating the UEs 1-M and instructing the BS to page the indicated UEs 1-M. The received BS-to-BS message can be a single (e.g., only one) message, in embodiments. The received BS-to-BS message can include a session ID of an MBS session of the MBS service and an indication of respective identifications of UEs 1-M that the BS is to page for an MBS service. In some implementations, the received BS-to-BS message also optionally includes an indication of a respective set of UE radio capabilities for each UE 1-M, where the respective sets of UE radio capabilities may be represented, for example, by respective capability IEs. For example, not all M UEs provide the indication of a respective set of radio capabilities (e.g., radio capability for paging) as they may not support such functions, and/or only a total number N respective set of radio capabilities out of the M UEs may available at the BS. The N indications of a respective set of radio capabilities may not necessary be different from each other.

In response to receiving 1003 the BS-to-BS message, the BS can generate 1007 a set of paging messages, e.g., a set of K different paging messages, each of which includes the ID of the MBS session of the MBS service. Subsequently, the remainder of method 1000B (e.g., steps 1006, 1008, and 1010) can be implemented by the BS in manner similar to that implemented by the DU in FIG. 10A.

With respect to FIG. 11, a RAN node can implement a method 1100 to page one or more UEs for an MBS service. For example, the RAN node can be a DU such as the DU 174 of the base station 104, or the RAN node can be an integrated base station. At a block 1102, the RAN node can determine 1102 to page a UE, e.g., after receiving instructions from another RAN node (e.g., a CU or another base station) or from a CN to do so. Next, the RAN node determines 1104 whether the RAN node can obtain UE radio capability information (e.g., UE radio capability for paging) for the UE that is to be paged. For example, as discussed above, in various embodiments and situations, a DU or a CU of a distributed base station can store UE-specific radio capability information. When the RAN node can obtain the specific radio capability information of the UE from a stored local location (e.g., from a DU or a CU), at block 1106 the RAN node obtains at least one UE radio configuration in accordance with the stored, specific radio capability information of the UE, and at block 1108 the RAN node transmits the paging message to the UE in accordance with the at least one first configuration corresponding to the stored, specific radio capability information of the UE.

On the other hand, when the RAN node is not able to obtain the specific radio capability information of the UE, at block 1100 the RAN node obtains at least one radio configuration in accordance with a predetermined or default set of UE radio capabilities. The predetermined or default set of UE radio capabilities can be stored, for example, at the RAN node (e.g., at a corresponding DU or CU). At a block 1112, the RAN node transmits the paging message to the UE in accordance with at least one first configuration in accordance with the predetermined or default UE radio capabilities.

In some implementations, the RAN node (e.g., a DU) receives a CU-to-DU message (e.g., F1 multicast paging message or F1 paging message) from a network node (e.g., a CU) and determines 1102 to page the UE in response to the received CU-to-DU message. In other implementations, the RAN node (e.g., a base station) receives a CN-to-BS message (e.g., NGAP multicast paging message, NGAP paging message, or Multicast Group Paging message) from a network node (e.g., an AMF) and determines 1102 to page the UE in response to receiving the CN-to-BS message. In yet other implementations, the RAN node (e.g., a base station) receives a BS-to-BS message (e.g., an Xn multicast paging message, Xn paging message, or RAN Multicast Group Paging) from a network node (e.g., from another base station) and determines 1102 to page the UE in response to receiving the BS-to-BS message. In still other implementations, the RAN node receives a MBS data packet (e.g., content data for the MBS service) from a network node, and determines 1102 to page the UE in response to receiving the MBS data packet.

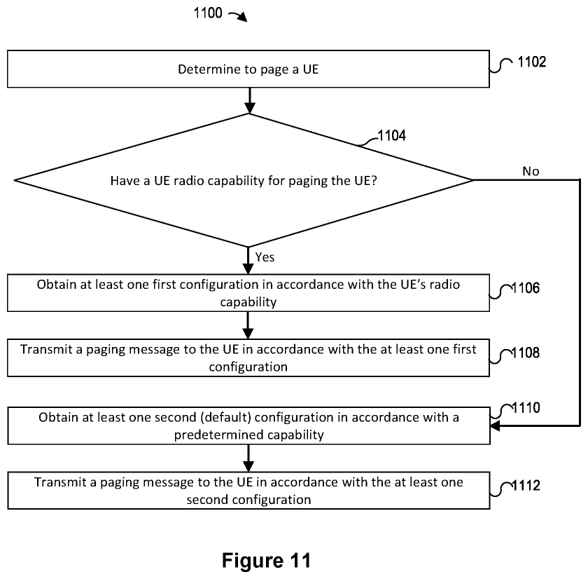

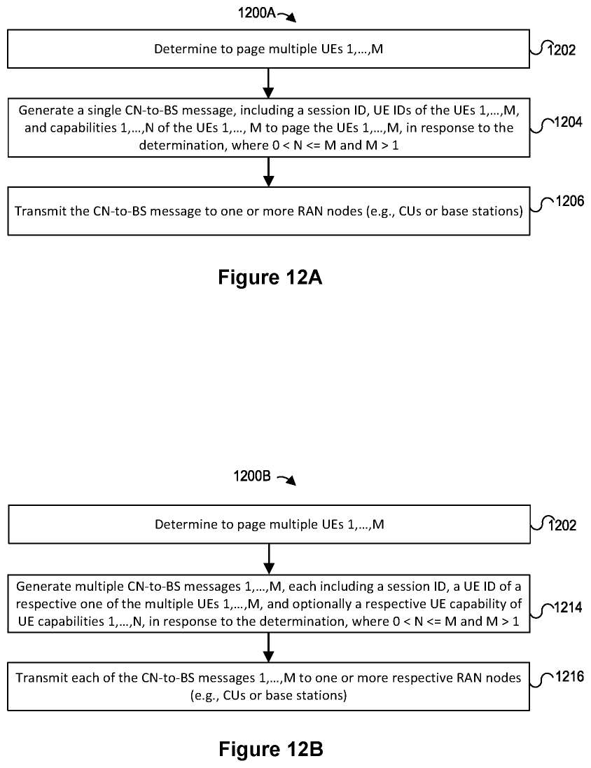

Now turning to FIG. 12A, a CN can implement a method 1200A to page one or more UEs for an MBS service. For example, the CN can be the CN 110. At block 1202, the CN can determine to page multiple UEs, e.g., UEs 1-M. In response to the determining 1202, the CN can generate 1204 a single CN-to-BS message, where the CN-to-BS message includes a session ID of the MBS session of the MBS service, an indication of the identifications of the UEs 1-M, and an indication of a respective set of UE radio capabilities for each UE 1-M, where the respective sets of UE radio capabilities can be represented, for example, by respective capability IEs, such as in a manner described above. For example, the CN-to-BS message can be a Multicast Group Paging message. Next, the CN can transmit 1206 the generated CN-to-BS message to one or more RAN nodes, e.g., to one or more CUs or base stations, which can include integrated base stations.

FIG. 12B depicts a method 1200B which can be implemented by a CN to page one or more UEs for an MBS service. For example, the CN can be the CN 110. Similar to the method 1200A, the method 1200B can include the CN determining 1202 to page UEs 1-M. However, instead of generating 1204 and transmitting 1206 a single CN-to-BS message as shown in FIG. 12A, in FIG. 12B the method 1200B includes the CN generating 1214 a respective CN-to-BS message for each of the UEs 1-M in response to the determining 1202. That is, the CN generates 1214 multiple CN-to-BS messages, each of which indicates a different UE 1-M. Each CN-to-BS message can include the session ID of the MBS service, an indication of the respective UE, and an indication of the specific set of radio capabilities of the indicated UE, which can be represented, for example, by a respective capability IE of the indicated UE, such as in a manner described above. The CN can transmit 1216 each of the generated CN-to-BS messages to one or more RAN nodes, e.g., to one or more CUs or base stations, which can include integrated base stations.

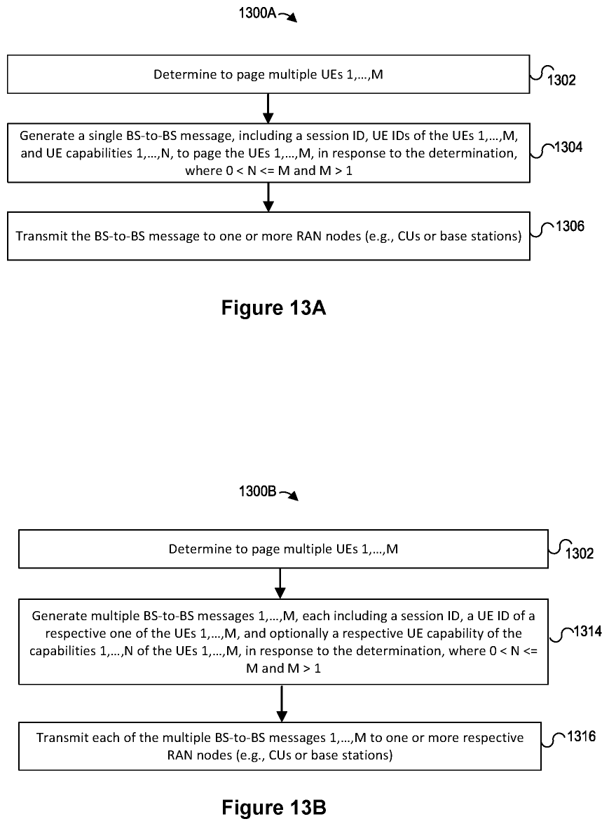

Now turning to FIG. 13A, a base station can implement a method 1300A to page one or more UEs for an MBS service. The base station can be an integrated or a distributed base station. For example, the base station can be the BS 104. At block 1302, the BS can determine to page multiple UEs, e.g., UEs 1-M. In response to the determining 1302, the BS can generate 1304 a single BS-to-BS message, where the BS-to-BS message includes a session ID of the MBS session of the MBS service, an indication of the identifications of the UEs 1-M, and an indication of a respective set of UE radio capabilities for each UE 1-M, where the respective sets of UE radio capabilities can be represented, for example, by respective capability IEs, such as in a manner described above. For example, the BS-to-BS message can be a RAN Multicast Group Paging message. Next, the BS can transmit 1306 the generated BS-to-BS message to one or more RAN nodes, e.g., to one or more CUs or base stations, which can include integrated base stations.

FIG. 13B depicts a method 1300B which can be implemented by a base station to page one or more UEs for an MBS service. The base station can be an integrated or a distributed base station. For example, the base station can be the base station 104. Similar to the method 1300A, the method 1300B can include the BS determining 1302 to page UEs 1-M. However, instead of generating 1304 and transmitting 1306 a single BS-to-BS message as shown in FIG. 13A, in FIG. 13B the method 1300B includes the BS generating 1314 a respective BS-to-BS message for each of the UEs 1-M in response to the determining 1302. That is, the BS generates 1314 multiple BS-to-BS messages, each of which indicates a different UE 1-M. Each BS-to-BS message can include the session ID of the MBS service, an indication of the respective UE, and an indication of the specific set of radio capabilities of the indicated UE, which can be represented, for example, by a respective capability IE of the indicated UE. The BS can transmit 1316 each of the generated BS-to-BS messages to one or more RAN nodes, e.g., to one or more CUs or base stations, which can be integrated base stations. For example, the BS-to-BS message can be a RAN Paging message.

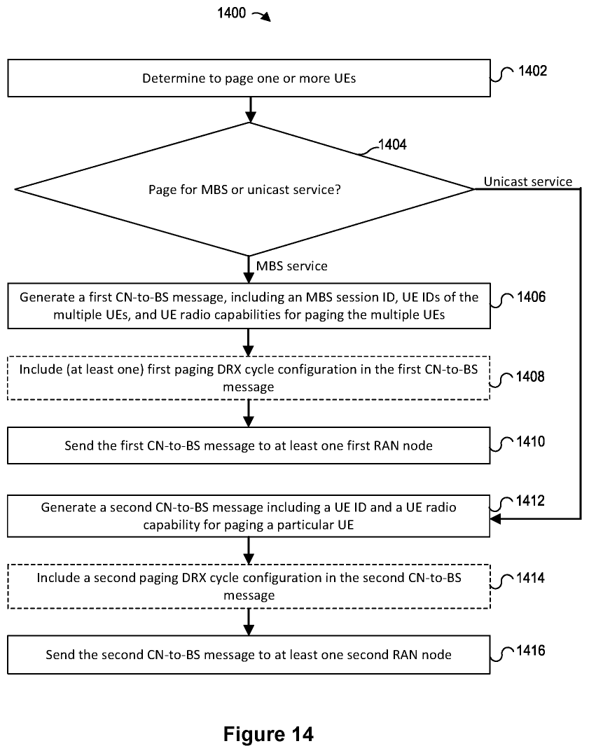

With respect to FIG. 14, a CN can implement a method 1400 to instruct one or base stations to page one or more UEs for an MBS service. For example, the CN can be the CN 110. The method 1400 begins at block 1402, where the CN determines to page one or more UEs for a service. At block 1404, the CN determines whether the service is an MBS service or a unicast service. When the CN determines 1404 that the service is an MBS service, the method 1400 proceeds to block 1406, at which the CN generates a first CN-to-BS message that includes the MBS session ID for the MBS service, an indication of the respective identifications of the one or more UEs, and an indication of respective sets of UE radio capabilities of the one or more UEs, which can be represented, for example, by a respective capability IE of each indicated UE. Additionally, at block 1408, the CN can optionally include, in the first CN-to-BS message, an indication of a respective discontinuous reception (DRX) cycle configuration for at least some of the UEs of the one or more UEs. At a block 1410, the CN can send or transmit the first CN-to-BS message to one or more RAN nodes, e.g., to one or more CUs and/or base stations, which can include integrated base stations.

On the other hand, when, at the block 1404, the CN determines that the service is a unicast service, the method 1400 proceeds to block 1412, at which the CN generates a second set of CN-to-BS messages, each of which corresponds to a different UE of the one or more UEs. For example, each CN-to-BS message included in the second set of CN-to-BS messages can include an indication of an identification of a respective UE, a session ID of the unicast service uniquely corresponding to the combination of the unicast service and the respective UE, and an indication of the UE radio capabilities of the respective UE. Additionally, at a block 1414, the CN can optionally include, in each CN-to-BS message, an indication of a respective DRX cycle configuration of the respective UE. At a block 1416, the CU can send or transmit the second set of CN-to-BS messages to one or more RAN nodes, which may be the same or a different set of RAN nodes to which the CN sent or transmitted the first CN-to-BS message.

Via the method 1400, a particular UE can be indicated for paging for the multicast service only, for the unicast service only, or for both the multicast service and the unicast service. Further, in some implementations, the first CN-to-BS message and the second set of CN-to-BS messages can be interface messages. For example, the interface messages can be NG interface messages such as next generation application protocol (NGAP) messages. In other implementations, the first CN-to-BS message can be a multicast paging interface message (e.g., a NGAP multicast paging message or Multicast Group Paging message), and/or the second set of CN-to-BS messages can be a set of paging interface messages (e.g., a set of NGAP paging messages).

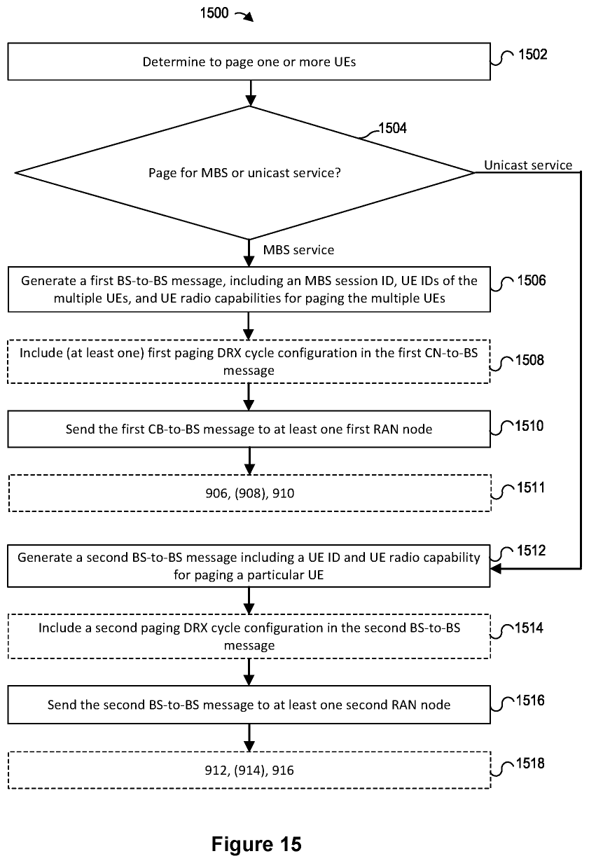

Turning now to FIG. 15, a base station can implement a method 1500 to instruct one or base other stations to page one or more UEs for an MBS service, e.g., to page one or more UEs which have moved from being located in the coverage area of the base station to being located in the coverage area of the one or more other base stations. The base station implementing the method 1500 can be an integrated base station or a distributed base station. For example, the base station can be the base station 104 or the base station 106. The method 1500 begins at block 1502, where the BS determines to page one or more UEs for a service. At block 1504, the BS determines whether the service is an MBS service or a unicast service. When the BS determines 1504 that the service is an MBS service, the method 1500 proceeds to block 1506, at which the BS generates a first BS-to-BS message that includes the MBS session ID for the MBS service, an indication of the respective identifications of the one or more UEs, and an indication of respective sets of UE radio capabilities of the one or more UEs, which can be represented, for example, by a respective capability IE of each indicated UE. Additionally, at block 1508, the BS can optionally include, in the first BS-to-BS message, an indication of a respective discontinuous reception (DRX) cycle configuration for at least some UEs of the one or more UEs. At a block 1510, the BS can send or transmit the first BS-to-BS message to one or more RAN nodes, e.g., to one or more CUs and/or base stations, which can include integrated base stations. Further, in some embodiments, at block 1511, the BS can perform or execute the events 906, 908, and/or 910 of FIG. 9, e.g., so that interested UEs which did not move out of the coverage area of the BS are paged by the BS for the MBS service.

On the other hand, when, at the block 1504, the BS determines that the service is a unicast service, the method 1500 proceeds to block 1512, at which the CN generates a second set of BS-to-BS messages, each of which corresponds to a different UE of the one or more UEs. For example, each BS-to-BS message included in the second set of BS-to-BS messages can include an indication of an identification of a respective UE, a session ID of the unicast service uniquely corresponding to the combination of the unicast service and the respective UE, and an indication of the UE radio capabilities of the respective UE. Additionally, at a block 1514, the CN can optionally include, in each BS-to-BS message, an indication of a respective DRX cycle configuration of the respective UE. At a block 1516, the BS can send or transmit the second set of BS-to-BS messages to one or more RAN nodes, which may be the same or a different set of RAN nodes to which the CN sent or transmitted the first BS-to-BS message. Further, in some embodiments, at block 1518, the BS can perform or execute events 912, 914, and/or 916 of FIG. 9, e.g., so that interested UEs which did not move out of the coverage area of the BS are paged by the BS for the MBS service.

Via the method 1500, a particular UE can be indicated for paging for the multicast service only, for the unicast service only, or for both the multicast service and the unicast service. Further, in some implementations, the first BS-to-BS message and the second BS-to-BS message can be interface messages. For example, the interface messages can be Xn interface messages such as Xn application protocol (XnAP) messages. In other implementations, the first BS-to-BS message can be a multicast paging interface message (e.g., an XnAP multicast paging message or RAN Multicast Group Paging message), and the set of second BS-to-BS messages can be a set of paging interface messages (e.g., a set of XnAP paging messages or RAN Paging messages).

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method, in a Core Network (CN) of a wireless communication system, for managing paging of multiple User Equipments (UEs) interested in a Multicast and/or Broadcast Services (MBS) service when respective radio connections between the multiple UEs and respective base stations of the wireless communication system are not active, the method comprising:
generating, by the CN, a single multicast paging message to page the multiple UEs interested in the MBS service, the single multicast paging message including an indication of a respective set of radio capabilities of each UE of the multiple UEs; and
transmitting, by the CN, the single multicast paging message to one or more base stations of the wireless communication system thereby causing the each UE to be paged in accordance with the respective set of radio capabilities for activating data reception of the MBS service.

2. The method of claim 1, further comprising, upon an activation of data reception of the MBS service at at least one of the multiple UEs, sending, by the CN, content data of the MBS service to the at least one of the multiple UEs via the MBS session.

3. The method of claim 1, wherein generating the single multicast paging message includes generating a single multicast paging message including a session identifier of an MBS session of the MBS service, respective identifications of the multiple UEs, and the indication of the respective set of radio capabilities of the each UE of the multiple UEs.

4. The method of claim 1, wherein generating the single multicast paging message includes generating the single multicast paging message responsive to receiving, by the CN, content data of the MBS service that is to be delivered to interested UEs.

5. The method of claim 1, wherein generating the single multicast paging message includes generating the single multicast paging message responsive to setting up, by the CN in conjunction with at least one of the one or more base stations, a respective set of resources corresponding to the MBS service.

6. The method of claim 1, wherein:
at least one UE of the multiple UEs is operating in an idle state;
the method further comprises storing, at the CN, an indication of the respective set of UE radio capabilities of the at least one UE operating in the idle state; and
generating the single multicast paging message that includes the indication of the respective set of radio capabilities of the each UE of the multiple UEs is based on the stored indication corresponding to the at least one UE operating in the idle state.

7. The method of claim 1, wherein at least one UE of the multiple UEs is operating in an idle state, and the method further comprises, subsequent to a respective activation of data reception of the MBS service at the at least one UE operating in the idle state:
sending, by the CN, content data of the MBS service to the at least one UE operating in the idle state.

8. The method of claim 1, wherein at least one UE of the multiple UEs is operating in an inactive state, and the method further comprises, subsequent to a respective activation of data reception of the MBS service at the at least one UE operating in the inactive state:
sending, by the CN, content data of the MBS service to the at least one UE operating in the inactive state.

9. The method of claim 1, wherein one or more UEs of the multiple UEs are operating in an inactive state or in an idle state, and the method further comprises, subsequent to a respective activation of data reception of the MBS service at the one or more UEs operating in the inactive state:
transitioning, by the CN in conjunction with the one or more UEs operating in the inactive state or in the idle state, the one or more UEs to operate in a connected state; and
sending, by the CN, content data of the MBS service to the one or more UEs operating in the connected state.

10. The method of claim 1, wherein:
at least one of the multiple UEs is operating in an inactive state corresponding to a respective radio connection with a first base station of the wireless communication system;
the method further comprises receiving, by the CN, a request to switch a path of the at least one of the multiple UEs from corresponding to the first base station to corresponding to a second base station of the wireless communication system; and
sending, by the CN, content data of the MBS service to the at least one of the multiple UEs via the second base station.

11. The method of claim 1,
further comprising determining, by the CN, to page the multiple UEs for an indicated service, and determining that the indicated service is the MBS service; and
wherein performing the method of claim 1 is responsive to determining that the indicated service is the MBS service.

12. The method of claim 1, further comprising including an indication of a respective discontinuous reception (DRX) cycle configuration corresponding to the each UE of the multiple UEs indicated in the single multicast paging message, the respective DRX cycle configuration corresponding to the each UE for the MBS service different than a respective DRX cycle configuration corresponding to the each UE for unicast services.

13. A node of a wireless communication system comprising processing hardware and configured to implement the method according to claim 1.

14-29. (canceled)

30. A Core Network (CN) of a wireless communication system, the CN comprising processing hardware and configured to implement the method of claim 1.

31. A wireless communication system comprising processing hardware and configured to implement the method of claim 1.
